(19) United States
(12) Patent Application Publication
(10) Pub. No.: US 2026/0170982 A1
(43) Pub. Date: Jun. 18, 2026

(54) DISPLAY SUBSTRATE AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Daiying ZHANG, Beijing (CN); Peng XU, Beijing (CN); Lu BAI, Beijing (CN); Junxiu DAI, Beijing (CN); Lei HE, Beijing (CN); Yujing LI, Beijing (CN); Weishu WEN, Beijing (CN); Guowei ZHAO, Beijing (CN)

(21) Appl. No.: 18/866,979

(22) PCT Filed: Jan. 23, 2024
(86) PCT No.: PCT/CN2024/073704

§ 371 Date: Nov. 18, 2024

(51) Int. Cl. G09G 3/20

(52) U.S. Cl. CPC G09G 3/20; G09G 2300/0408; G09G 2300/0426; G09G 2310/0267; G09G 2310/0286; G09G 2310/08

(57) ABSTRACT

A display substrate includes a base substrate, a scan line and a driving module arranged on the base substrate, at least two transistors in the driving circuit have a first gate electrode and a second gate electrode; at least a portion of the second gate electrode is located between the first gate electrode and the base substrate; bottom gate via holes of at least two transistors of the driving circuit are arranged along a first direction; the second gate electrode is electrically connected to a connection portion through the bottom gate via hole, and the connection portion is electrically connected to the first gate electrode; or, the second gate electrode is electrically connected to the first gate electrode through the bottom gate via hole; the first direction intersects with a second direction, and the scan line includes at least a portion extending along the second direction.

### CROSS-REFERENCE TO RELATED APPLICATION

The present disclosure is the U.S. national phase of PCT Application No. PCT/CN2024/073704 filed on Jan. 23, 2024, which is incorporated herein by reference in its entirety for all purposes.

### TECHNICAL FIELD

The present disclosure relates to the field of display technology, in particular to a display substrate and a display device.

### BACKGROUND

Currently, consumers have higher and higher requirements for the screen-to-body ratio of mobile display devices, which means that narrowing the border has become a major trend. GOA (Gate on array, a gate driving circuit set on an array substrate) circuits are usually designed to be arranged on both sides of the pixel circuit. The cascaded GOA circuits include a large number of capacitors, thin film transistors and signal lines. At the same time, the number of GOA control units increases, which takes up a lot of space. Therefore, it is necessary to reasonably design the placement of devices and shared signal routing to reduce the space occupied by the GOA circuit and facilitate the narrowing of the display border.

### SUMMARY

In one aspect, the present disclosure provides in some embodiments a display substrate, including a base substrate, a scan line and a driving module arranged on the base substrate, wherein the driving module includes a plurality of stages of driving circuits, and the driving circuit is configured to provide a driving signal for the scan line; at least two transistors in the driving circuit have a first gate electrode and a second gate electrode; at least a portion of the second gate electrode is located between the first gate electrode and the base substrate; bottom gate via holes of at least two transistors of the driving circuit are arranged along a first direction; the second gate electrode is electrically connected to a connection portion through the bottom gate via hole, and the connection portion is electrically connected to the first gate electrode; or, the second gate electrode is electrically connected to the first gate electrode through the bottom gate via hole; the first direction intersects with a second direction, and the scan line includes at least a portion extending along the second direction.

Optionally, an orthographic projection of a bottom gate via hole of at least one transistor included in the driving circuit on the base substrate and an orthographic projection of an electrode of another transistor electrically connected to the at least one transistor on the base substrate are arranged along the first direction.

Optionally, a minimum distance between an orthographic projection of a bottom gate via hole of at least one transistor included in the driving circuit and an orthographic projection of an electrode of another transistor electrically connected to the at least one transistor on the base substrate is smaller than a distance threshold.

Optionally, the driving circuit comprises an output circuit, the output circuit is electrically connected to a first output node, a second output node and a driving signal output terminal respectively, and is configured to generate a driving signal under the control of a potential of the first output node and a potential of the second output node, and provide the driving signal through the driving signal output terminal; a length of an active pattern of at least one transistor included in the output circuit along the second direction is smaller than a first length threshold.

Optionally, the active pattern includes N mutually independent active pattern portions, the active pattern portions extend along the second direction, and N is an integer greater than 1.

Optionally, the driving circuit includes at least one energy storage circuit, and the energy storage circuit includes a capacitor; a length of an orthographic projection of at least one capacitor included in the driving circuit on the base substrate along the second direction is smaller than a second length threshold.

Optionally, the driving circuit includes a first node control circuit, a second node control circuit, a first output node setting circuit, a third node control circuit, a first output node control circuit, a control node control circuit, a second output node control circuit, a first energy storage circuit, and an output circuit; the first node control circuit is electrically connected to the first node and is configured to control a potential of the first node; the second node control circuit is electrically connected to the second node and is configured to control a potential of the second node; the first output node setting circuit is electrically connected to a control node, a first output node and a first voltage line respectively, and is configured to control the connection between the first output node and the first voltage line under the control of a potential of the control node; the third node control circuit is electrically connected to a first node and a third node respectively, and is configured to control a potential of the third node under the control of a potential of the first node; the first output node control circuit is electrically connected to the third node, a second clock signal line and the first output node respectively, and is configured to control the connection or disconnection between the third node and the first output node under the control of a second clock signal provided by the second clock signal line; the control node control circuit is electrically connected to an initial control line, the first voltage line and the control node respectively, and is configured to control the connection or disconnection between the control node and the first voltage line under the control of an initial control signal provided by the initial control line; the second output node control circuit is electrically connected to a second output node and a fourth node respectively, and is configured to control a potential of the second output node according to a potential of the fourth node; the first energy storage circuit is electrically connected to the second node and the fourth node respectively, and is configured to store electrical energy; the output circuit is electrically connected to the first output node, the second output node and the driving signal output terminal respectively, and is configured to control to output the driving signal under the control of a potential of the first output node and a potential of the second output node, and provide the driving signal through the driving signal output terminal.

Optionally, the first node control circuit includes a first transistor, and the second node control circuit includes a second transistor; the first output node setting circuit includes a third transistor, and the first output node control circuit includes a fourth transistor; the first energy storage circuit includes a first capacitor; the control node control circuit includes a fifth transistor, the second output node control circuit includes a sixth transistor; the output circuit includes a seventh transistor and an eighth transistor; a first gate electrode of the first transistor is electrically connected to a first clock signal line, a first electrode of the first transistor is electrically connected to a second voltage line, and a second electrode of the first transistor is electrically connected to the first node; a first gate electrode of the second transistor is electrically connected to the first node, a first electrode of the second transistor is electrically connected to the first voltage line, and a second electrode of the second transistor is electrically connected to the second node; a first gate electrode of the third transistor is electrically connected to the control node, a first electrode of the third transistor is electrically connected to the first voltage line, and a second electrode of the third transistor is electrically connected to the first output node; a first gate electrode of the fourth transistor is electrically connected to the second clock signal line, a first electrode of the fourth transistor is electrically connected to the third node, and a second electrode of the fourth transistor is electrically connected to the first output node; a first gate electrode of the fifth transistor is electrically connected to the initial control line, a first electrode of the fifth transistor is electrically connected to the first voltage line, and a second electrode of the fifth transistor is electrically connected to the control node; a first gate electrode of the sixth transistor and a first electrode of the sixth transistor are electrically connected to the third node, and a second electrode of the sixth transistor is electrically connected to the second output node; a first gate electrode of the seventh transistor is electrically connected to the first output node, a first electrode of the seventh transistor is electrically connected to the first voltage line, and a second electrode of the seventh transistor is electrically connected to the driving signal output terminal; a first gate electrode of the eighth transistor is electrically connected to the second output node, a first electrode of the eighth transistor is electrically connected to the driving signal output terminal, and a second electrode of the eighth transistor is electrically connected to the second voltage line; a first electrode plate of the first capacitor is electrically connected to the second node, and a second electrode plate of the first capacitor is electrically connected to the fourth node.

Optionally, an orthographic projection of a bottom gate via hole of the fourth transistor on the base substrate, an orthographic projection of a bottom gate via hole of the seventh transistor on the base substrate, an orthographic projection of a bottom gate via hole of the third transistor on the base substrate, an orthographic projection of a bottom gate via hole of the fifth transistor on the base substrate and an orthographic projection of a bottom gate via hole of the eighth transistor on the base substrate are arranged along the first direction.

Optionally, an orthographic projection of a bottom gate via hole of the second transistor on the base substrate and an orthographic projection of the second electrode of the first transistor on the base substrate are arranged along the first direction.

Optionally, the control node is directly connected to the second output node; or, the driving circuit also includes a first on-off control circuit; the first on-off control circuit is electrically connected to the second voltage line, the control node and the second output node respectively, and is configured to control the connection or disconnection between the control node and the second output node under the control of a second voltage signal provided by the second voltage line.

Optionally, the driving circuit further includes a first on-off control circuit; the first on-off control circuit includes a ninth transistor; a first gate electrode of the ninth transistor is electrically connected to the second voltage line, a first electrode of the ninth transistor is electrically connected to the control node, and a second electrode of the ninth transistor is electrically connected to the second output node; an orthographic projection of a bottom gate via hole of the ninth transistor on the base substrate and an orthographic projection of a bottom gate via hole of the sixth transistor on the base substrate are arranged along the first direction.

Optionally, a length of an orthographic projection of the first capacitor on the base substrate along the second direction is smaller than a second length threshold.

Optionally, a length of the active pattern of the eighth transistor along the second direction is smaller than a first length threshold.

Optionally, the driving circuit includes a first node control circuit, a second node control circuit, a third node control circuit, a first output node control circuit, a first output node setting circuit, a control node control circuit, an output circuit, a first energy storage circuit, a second energy storage circuit, and a third energy storage circuit; the first node control circuit is electrically connected to the first node and is configured to control the potential of the first node; the second node control circuit is electrically connected to the second node and is configured to control the potential of the second node; the first output node setting circuit is electrically connected to the control node, the first output node and the first voltage line respectively, and is configured to control the connection between the first output node and the first voltage line under the control of the potential of the control node; the third node control circuit is electrically connected to the fifth node and the third node respectively, and is configured to control the potential of the third node under the control of the potential of the fifth node; the first output node control circuit is electrically connected to the third node, the second clock signal line and the first output node respectively, and is configured to control the connection or disconnection between the third node and the first output node under the control of the second clock signal provided by the second clock signal line; the control node control circuit is electrically connected to the input terminal, the first clock signal line, the initial control line, the first voltage line and the control node respectively, and is configured to control the connection or disconnection between the control node and the first voltage line under the control of the initial control signal provided by the initial control line, and control the connection or disconnection between the control node and the input terminal under the control of the first clock signal provided by the first clock signal line; the first energy storage circuit is electrically connected to the second node and the second output node respectively, and is configured to store electrical energy; a first terminal of the second energy storage circuit is electrically connected to the first node, a second terminal of the second energy storage circuit is electrically connected to the third node, and the second energy storage circuit is configured to store electrical energy; the third energy storage circuit is electrically connected to the first output node and is configured to maintain the potential of the first output node; the output circuit is electrically connected to the first output node, the second output node and the driving signal output terminal respectively, and is configured to control to output the driving signal under the control of the potential of the first output node and the potential of the second output node, and provide the driving signal through the driving signal output terminal.

Optionally, the first node control circuit includes a first transistor and a thirteenth transistor, and the second node control circuit includes a second transistor and a tenth transistor; the first output node setting circuit includes a third transistor, and the first output node control circuit includes a fourth transistor; the first energy storage circuit includes a first capacitor; the second energy storage circuit includes a second capacitor, and the third energy storage circuit includes a third capacitor; the control node control circuit includes a fifth transistor and an eleventh transistor, and the output circuit includes a seventh transistor and an eighth transistor; the third node control circuit includes a twelfth transistor; a first gate electrode of the first transistor is electrically connected to a first clock signal line, a first electrode of the first transistor is electrically connected to a second voltage line, and a second electrode of the first transistor is electrically connected to the first node; a first gate electrode of the thirteenth transistor is electrically connected to the control node, a first electrode of the thirteenth transistor is electrically connected to the first clock signal line, and a second electrode of the thirteenth transistor is electrically connected to the first node; a first gate electrode of the second transistor is electrically connected to the first node, a first electrode of the second transistor is electrically connected to a first voltage line, and a second electrode of the second transistor is electrically connected to the second node; a first gate electrode of the tenth transistor is electrically connected to the second output node, a first electrode of the tenth transistor is electrically connected to the second clock signal line, and a second electrode of the tenth transistor is electrically connected to the second node; a first gate electrode of the third transistor is electrically connected to the control node, a first electrode of the third transistor is electrically connected to a first voltage line, and a second electrode of the third transistor is electrically connected to the first output node; a first gate electrode of the fourth transistor is electrically connected to the second clock signal line, a first electrode of the fourth transistor is electrically connected to the third node, and a second electrode of the fourth transistor is electrically connected to the first output node; a first gate electrode of the fifth transistor is electrically connected to the initial control line, a first electrode of the fifth transistor is electrically connected to the first voltage line, and a second electrode of the fifth transistor is electrically connected to the control node; a first gate electrode of the eleventh transistor is electrically connected to the first clock signal line, a first electrode of the eleventh transistor is electrically connected to the input terminal, and a second electrode of the eleventh transistor is electrically connected to the control node; a first gate electrode of the seventh transistor is electrically connected to the first output node, a first electrode of the seventh transistor is electrically connected to the first voltage line, and a second electrode of the seventh transistor is electrically connected to the driving signal output terminal; a first gate electrode of the eighth transistor is electrically connected to the second output node, a first electrode of the eighth transistor is electrically connected to the driving signal output terminal, and a second electrode of the eighth transistor is electrically connected to the second voltage line; a first gate electrode of the twelfth transistor is electrically connected to the first node, a first electrode of the twelfth transistor is electrically connected to the second clock signal line, and a second electrode of the twelfth transistor is electrically connected to the third node; a first electrode plate of the first capacitor is electrically connected to the second node, and a second electrode plate of the first capacitor is electrically connected to the second output node; a first electrode plate of the second capacitor is electrically connected to the first node, and a second electrode plate of the second capacitor is electrically connected to the third node; a first electrode plate of the third capacitor is electrically connected to the first output node, and a second electrode plate of the third capacitor is electrically connected to the first voltage line.

Optionally, an orthographic projection of an electrode plate of the second capacitor on the base substrate is at least partially arranged around an orthographic projection of a bottom gate via hole of the eleventh transistor on the base substrate.

Optionally, an orthographic projection of the second electrode of the eleventh transistor on the base substrate and an orthographic projection of a bottom gate via hole of the thirteenth transistor on the base substrate are arranged along the first direction.

Optionally, an orthographic projection of a bottom gate via hole of the thirteenth transistor on the base substrate and an orthographic projection of the first electrode of the first transistor on the base substrate are arranged along the first direction.

Optionally, an orthographic projection of a bottom gate via hole of the twelfth transistor on the base substrate, an orthographic projection of a bottom gate via hole of the seventh transistor on the base substrate and an orthographic projection of a bottom gate via hole of the fifth transistor on the base substrate are arranged along the first direction.

Optionally, an orthographic projection of a bottom gate via hole of the fourth transistor on the base substrate and an orthographic projection of the second electrode of the third transistor on the base substrate are arranged along the second direction.

Optionally, an orthographic projection of a bottom gate via hole of the tenth transistor on the base substrate and an orthographic projection of a electrode plate of the first capacitor on the base substrate are arranged along the second direction.

Optionally, a length of an active pattern of the eighth transistor along the second direction is smaller than a first length threshold.

Optionally, the control node is directly connected to the second output node; the first node is electrically connected to a fifth node; or the driving circuit further includes a first on-off control circuit and a second on-off control circuit; the first on-off control circuit is electrically connected to the second voltage line, the control node and the second output node respectively, and is configured to control the connection or disconnection between the control node and the second output node under the control of the second voltage signal provided by the second voltage line; the second on-off control circuit is electrically connected to the second voltage line, the first node and the fifth node respectively, and is configured to control the connection or disconnection between the first node and the fifth node under the control of the second voltage signal provided by the second voltage line.

Optionally, the driving circuit comprises a first output node control circuit, a sixth node control circuit, a second output node control circuit and an output circuit; the first output node control circuit is configured to control a potential of the first output node; the sixth node control circuit is configured to control a potential of the sixth node; the second output node control circuit is configured to control a potential of the second output node according to the potential of the sixth node; the output circuit is configured to control to provide the driving signal through the driving signal output terminal under the control of the potential of the first output node and the potential of the second output node.

Optionally, the first output node control circuit comprises a first transistor and a ninth transistor; a first gate electrode of the first transistor is electrically connected to a first clock signal line, a first electrode of the first transistor is electrically connected to a second voltage line, and a second electrode of the first transistor is electrically connected to the first output node; a first gate electrode of the ninth transistor is electrically connected to the sixth node, a first electrode of the ninth transistor is electrically connected to the first clock signal line, and a second electrode of the ninth transistor is electrically connected to the first output node; the sixth node control circuit includes an eleventh transistor, a fourteenth transistor and a fifteenth transistor; a first gate electrode of the eleventh transistor is electrically connected to the first clock signal line, a first electrode of the eleventh transistor is electrically connected to the input terminal, and a second electrode of the eleventh transistor is electrically connected to the sixth node; a first gate electrode of the fourteenth transistor is electrically connected to the first output node, a first electrode of the fourteenth transistor is electrically connected to the first voltage line, and a second electrode of the fourteenth transistor is electrically connected to a first electrode of the fifteenth transistor; a first gate electrode of the fifteenth transistor is electrically connected to the second clock signal line, and a second electrode of the fifteenth transistor is electrically connected to the sixth node; the second output node control circuit includes a sixteenth transistor; a first gate electrode of the sixteenth transistor is electrically connected to the second voltage line, a first electrode of the sixteenth transistor is electrically connected to the sixth node, and a second electrode of the sixteenth transistor is electrically connected to the second output node; the output circuit includes a seventh transistor and an eighth transistor; a first gate electrode of the seventh transistor is electrically connected to the first output node, a first electrode of the seventh transistor is electrically connected to the first voltage line, and a second electrode of the seventh transistor is electrically connected to the driving signal output terminal; a first gate electrode of the eighth transistor is electrically connected to the second output node, a first electrode of the eighth transistor is electrically connected to the driving signal output terminal, and a second electrode of the eighth transistor is electrically connected to the second clock signal line.

Optionally, an orthographic projection of a bottom gate via hole of the eleventh transistor on the base substrate, an orthographic projection of a bottom gate via hole of the ninth transistor on the base substrate, and an orthographic projection of a bottom gate via hole of the sixteenth transistor on the base substrate are arranged along the first direction.

Optionally, an orthographic projection of a bottom gate via hole of the seventh transistor on the base substrate and an orthographic projection of a bottom gate via hole of the eighth transistor on the base substrate are arranged along the first direction.

Optionally, the eleventh transistor in a current stage of driving circuit, the first transistor in the current stage of driving circuit and the fifteenth transistor in an adjacent previous stage of driving circuit share a bottom gate via hole.

In a second aspect, an embodiment of the present disclosure provides a display device including the display substrate.

### BRIEF DESCRIPTION OF THE DRAWINGS

FIG. 1 is a structure diagram showing a driving circuit in a display substrate according to one embodiment of the present disclosure;

FIG. 2 is a circuit diagram showing a driving circuit in a display substrate according to one embodiment of the present disclosure;

FIG. 3 is a timing diagram of the operation of the driving circuit shown in FIG. 2;

FIGS. 4A and 4B are layout diagrams of the driving circuit shown in FIG. 2;

FIG. 5 is a layout diagram of the light shielding metal layer in FIG. 4A;

FIG. 6 is a layout diagram of the semiconductor layer in FIG. 4A;

FIG. 7 is a layout diagram of the first gate electrode metal layer in FIG. 4A;

FIG. 8 is a layout diagram of the second gate electrode metal layer in FIG. 4A;

FIG. 9 is a layout diagram of the first source-drain metal layer in FIG. 4A;

FIG. 10 is a layout diagram of the second source-drain metal layer in FIG. 4A;

FIG. 11A is a schematic diagram of the superposition of the semiconductor layer and the first gate electrode metal layer in FIG. 4A;

FIG. 11B is a schematic diagram of the superposition of the first gate electrode metal layer, the second gate electrode metal layer and the first source-drain metal layer in FIG. 4A;

FIG. 11C is a schematic diagram of the superposition of the first source-drain metal layer and the second source-drain metal layer in FIG. 4A;

FIG. 11D is a schematic diagram showing the superposition of the light shielding metal layer and the semiconductor layer in FIG. 4A

FIG. 12 is a structural diagram of a driving circuit in a display substrate according to at least one embodiment of the present disclosure;

FIG. 13 is a circuit diagram showing a driving circuit in a display substrate according to at least one embodiment of the present disclosure;

FIGS. 14A and 14B are layout diagrams of the driving circuit shown in FIG. 13;

FIG. 15 is a layout diagram of the light shielding metal layer in FIG. 14A;

FIG. 16 is a layout diagram of the semiconductor layer in FIG. 14A;

FIG. 17 is a layout diagram of the first gate electrode metal layer in FIG. 14A;

FIG. 18 is a layout diagram of the second gate electrode metal layer in FIG. 14A;

FIG. 19 is a layout diagram of the third gate metal layer in FIG. 14A;

FIG. 20 is a layout diagram of the first source-drain metal layer in FIG. 14A;

FIG. 21 is a layout diagram of the second source-drain metal layer in FIG. 14A;

FIG. 22A is a schematic diagram of the superposition of the semiconductor layer and the first gate electrode metal layer in FIG. 14A;

FIG. 22B is a schematic diagram of the superposition of the first gate electrode metal layer, the second gate electrode metal layer, and the first source-drain metal layer in FIG. 14A;

FIG. 22C is a layout diagram of the first source-drain metal layer and the second source-drain metal layer in FIG. 14A;

FIG. 22D is a layout diagram of the light shielding metal layer and the semiconductor layer in FIG. 14A;

FIG. 23 is a structure diagram showing a driving circuit in a display substrate according to at least one embodiment of the present disclosure;

FIG. 24 is a circuit diagram showing a driving circuit in a display substrate according to at least one embodiment of the present disclosure;

FIGS. 25A and 25B are layout diagrams of the driving circuit shown in FIG. 24;

FIG. 26 is a layout diagram of the light shielding metal layer in FIG. 25A;

FIG. 27 is a layout diagram of the semiconductor layer in FIG. 25A;

FIG. 28 is a layout diagram of the first gate electrode metal layer in FIG. 25A;

FIG. 29 is a layout diagram of the second gate electrode metal layer in FIG. 25A;

FIG. 30 is a layout diagram of the first source-drain metal layer in FIG. 25A;

FIG. 31 is a layout diagram of the second source-drain metal layer in FIG. 25A.

FIG. 32A is a schematic diagram of the superposition of the semiconductor layer and the first gate electrode metal layer in FIG. 25A;

FIG. 32B is a schematic diagram of the superposition of the first source-drain metal layer and the second source-drain metal layer in FIG. 25A;

FIG. 32C is a schematic diagram of the superposition of the first gate electrode metal layer, the second gate electrode metal layer, and the first source-drain metal layer in FIG. 25A;

FIG. 32D is a schematic diagram showing the superposition of the light shielding metal layer and the semiconductor layer in FIG. 25A.

### DETAILED DESCRIPTION

The following will be combined with the drawings in the embodiments of the present disclosure to clearly and completely describe the technical solutions in the embodiments of the present disclosure. Obviously, the described embodiments are only part of the embodiments of the present disclosure, rather than all the embodiments. Based on the embodiments in the present disclosure, all other embodiments obtained by ordinary skilled in the art without making creative work are within the scope of protection of the present disclosure.

All embodiments of the present disclosure may be thin film transistors or field effect transistors or other devices with the same characteristics. In the embodiments of the present disclosure, to distinguish the two electrodes of the transistor except the gate electrode, one of the electrodes is called the first electrode and the other is called the second electrode.

In actual operation, when the transistor is a thin film transistor or a field effect transistor, the first electrode may be a drain electrode, and the second electrode may be a source electrode; or, the first electrode may be a source electrode, and the second electrode may be a drain electrode.

An embodiment of the present disclosure includes a base substrate, a scan line and a driving module arranged on the base substrate, the driving module includes a plurality of stages of driving circuits, and the driving circuit is configured to provide a driving signal for the scan line;

At least two transistors in the driving circuit have a first gate electrode and a second gate electrode; at least a portion of the second gate electrode is located between the first gate electrode and the base substrate;
bottom gate via holes of at least two transistors of the driving circuit are arranged along a first direction;

The second gate electrode is electrically connected to a connection portion through the bottom gate via hole, and the connection portion is electrically connected to the first gate electrode; or, the second gate electrode is electrically connected to the first gate electrode through the bottom gate via hole;

The first direction intersects with a second direction, and the scan line includes at least a portion extending along the second direction.

In the relevant driving circuit, the transistor is usually a single-gate design, which adopts a top-gate solution in which the first gate electrode metal layer is placed above the semiconductor layer. However, under this structure, the characteristics of the transistor are prone to deviation. In order to ensure the stability of the transistor characteristics, in at least one embodiment of the present disclosure, a light shielding metal layer is added to a side of the semiconductor layer of the transistor close to the base substrate. The light shielding metal layer includes the second gate electrode of the transistor, forming a dual-gate design of top-bottom gate electrodes. The newly added second gate electrode needs to be connected to the first gate electrode of the transistor through a transfer hole, and the layout space needs to be optimized to reduce the border.

In at least one embodiment of the present disclosure, bottom gate via holes of at least two transistors of the driving circuit are arranged along the first direction to narrow the lateral space occupied by the driving circuit, thereby facilitating the realization of a narrow frame.

In the specific implementation, since the punched connectors take up a large space when the lines jump between layers, it is necessary to avoid staggered arrangement of the punched adapters, and place as many adapter holes as possible in the same column to facilitate space compression.

Optionally, the first direction may be a vertical direction, and the second direction may be a horizontal direction, but is not limited thereto.

In at least one embodiment of the present disclosure, an orthographic projection of a bottom gate via hole of at least one transistor included in the driving circuit on the base substrate and an orthographic projection of an electrode of another transistor electrically connected to the transistor on the base substrate are arranged along a first direction.

Optionally, the electrode of the other transistor electrically connected to the transistor may be a first electrode or a second electrode, but is not limited thereto.

In a specific implementation, the bottom gate via hole of the transistor can be arranged close to the first electrode and/or the second electrode of another transistor electrically connected to the transistor, thereby reducing the length of the transfer hole connection while avoiding the transistor structure, thereby compressing the layout space.

Optionally, the distance threshold may be greater than or equal to 1 μm and less than or equal to 2 μm, but is not limited thereto.

In at least one embodiment of the present disclosure, the driving circuit includes an output circuit, the output circuit is electrically connected to the first output node, the second output node and the driving signal output terminal respectively, and is configured to generate a driving signal under the control of a potential of the first output node and a potential of the second output node, and provide the driving signal through the driving signal output terminal;

A length of an active pattern of at least one transistor included in the output circuit along the second direction is smaller than the first length threshold.

In a specific implementation, the driving circuit may include an output circuit, which generates a driving signal under the control of the potential of the first output node and the potential of the second output node. The length of the active pattern of at least one transistor included in the output circuit along the second direction is smaller, that is, the width of the active pattern of at least one transistor included in the output circuit along the horizontal direction is narrowed, which is conducive to achieving a narrow frame.

Optionally, the first length threshold may be greater than or equal to 45 μm and less than or equal to 55 μm, but is not limited thereto.

In at least one embodiment of the present disclosure, the active pattern includes N mutually independent active pattern portions, the active pattern portions extend along the second direction, and N is an integer greater than 1.

In at least one embodiment of the present disclosure, the driving circuit includes at least one energy storage circuit, and the energy storage circuit includes a capacitor;

A length of an orthographic projection of at least one capacitor included in the driving circuit on the base substrate along the second direction is smaller than a second length threshold.

In a specific implementation, the length of the orthographic projection of at least one capacitor in the driving circuit on the base substrate along the second direction can be set to be relatively small, which is conducive to achieving a narrow frame.

Optionally, the second length threshold may be greater than or equal to 25 μm and less than or equal to 36 μm, but is not limited thereto.

In at least one embodiment of the present disclosure, the driving circuit includes a first node control circuit, a second node control circuit, a first output node setting circuit, a third node control circuit, a first output node control circuit, a control node control circuit, a second output node control circuit, a first energy storage circuit, and an output circuit;

The first node control circuit is electrically connected to the first node and is configured to control the potential of the first node;

The first output node setting circuit is electrically connected to the control node, the first output node and the first voltage line respectively, and is configured to control the connection between the first output node and the first voltage line under the control of the potential of the control node;

The third node control circuit is electrically connected to the first node and the third node respectively, and is configured to control the potential of the third node under the control of the potential of the first node;

The first output node control circuit is electrically connected to the third node, the second clock signal line and the first output node respectively, and is configured to control the connection or disconnection between the third node and the first output node under the control of the second clock signal provided by the second clock signal line;

The control node control circuit is electrically connected to the initial control line, the first voltage line and the control node respectively, and is configured to control the connection or disconnection between the control node and the first voltage line under the control of the initial control signal provided by the initial control line;

The second output node control circuit is electrically connected to the second output node and the fourth node respectively, and is configured to control the potential of the second output node according to the potential of the fourth node;

The first energy storage circuit is electrically connected to the second node and the fourth node respectively, and is configured to store electrical energy;

The output circuit is electrically connected to the first output node, the second output node and the driving signal output terminal respectively, and is configured to control to output the driving signal under the control of the potential of the first output node and the potential of the second output node, and provide the driving signal through the driving signal output terminal.

Optionally, the first voltage line may be a high voltage line, but is not limited thereto.

Optionally, the first node control circuit includes a first transistor, and the second node control circuit includes a second transistor; the first output node setting circuit includes a third transistor, and the first output node control circuit includes a fourth transistor; the first energy storage circuit includes a first capacitor;

The control node control circuit includes a fifth transistor, the second output node control circuit includes a sixth transistor; the output circuit includes a seventh transistor and an eighth transistor;

A first gate electrode of the first transistor is electrically connected to a first clock signal line, a first electrode of the first transistor is electrically connected to a second voltage line, and a second electrode of the first transistor is electrically connected to the first node;

A first gate electrode of the second transistor is electrically connected to the first node, a first electrode of the second transistor is electrically connected to a first voltage line, and a second electrode of the second transistor is electrically connected to the second node;

A first gate electrode of the third transistor is electrically connected to the control node, a first electrode of the third transistor is electrically connected to a first voltage line, and a second electrode of the third transistor is electrically connected to the first output node;

A first gate electrode of the fourth transistor is electrically connected to the second clock signal line, a first electrode of the fourth transistor is electrically connected to the third node, and a second electrode of the fourth transistor is electrically connected to the first output node;
a first gate electrode of the fifth transistor is electrically connected to the initial control line, a first electrode of the fifth transistor is electrically connected to the first voltage line, and a second electrode of the fifth transistor is electrically connected to the control node;
a first gate electrode of the sixth transistor and a first electrode of the sixth transistor are electrically connected to the third node, and a second electrode of the sixth transistor is electrically connected to the second output node;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second voltage line;
a first electrode plate of the first capacitor is electrically connected to the second node, and a second electrode plate of the first capacitor is electrically connected to the fourth node.

In at least one embodiment of the present disclosure, the orthographic projection of the bottom gate via hole of the fourth transistor on the base substrate, the orthographic projection of the bottom gate via hole of the seventh transistor on the base substrate, the orthographic projection of the bottom gate via hole of the third transistor on the base substrate, the orthographic projection of the bottom gate via hole of the fifth transistor on the base substrate and the orthographic projection of the bottom gate via hole of the eighth transistor on the base substrate are arranged along a first direction.

In at least one embodiment of the present disclosure, the control node is directly connected to the second output node; or,

The driving circuit also includes a first on-off control circuit;

The first on-off control circuit is electrically connected to the second voltage line, the control node and the second output node respectively, and is configured to control the connection or disconnection between the control node and the second output node under the control of a second voltage signal provided by the second voltage line.

In a specific implementation, the control node can be directly connected to the second output node; or, the driving circuit also includes a first on-off control circuit; the control node is electrically connected to the second output node through the first on-off control circuit, and the first on-off control circuit controls the connection or disconnection between the control node and the second output node under the control of a second voltage signal.

Optionally, when the transistor included in the first on-off control circuit is a p-type transistor, the second voltage line may be a low voltage line;

When the transistor included in the first on-off control circuit is an n-type transistor, the second voltage line may be a high voltage line.

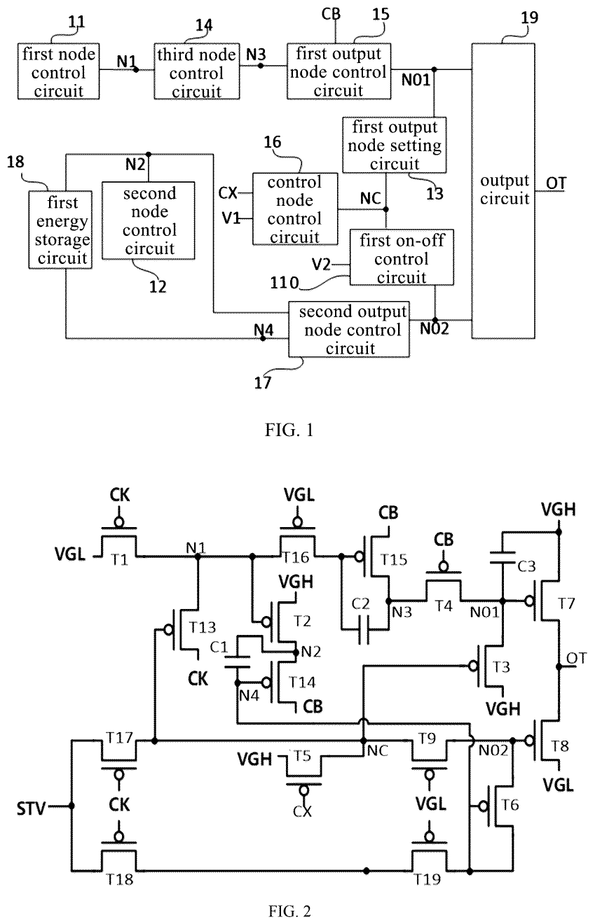

As shown in FIG. 1, one embodiment of the driving circuit may include a first node control circuit 11, a second node control circuit 12, a first output node setting circuit 13, a third node control circuit 14, a first output node control circuit 15, a control node control circuit 16, a second output node control circuit 17, a first energy storage circuit 18, an output circuit 19, and a first on-off control circuit 110;

The first node control circuit 11 is electrically connected to the first node N1 and is configured to control the potential of the first node N1;

The second node control circuit 12 is electrically connected to the second node N2, and is configured to control the potential of the second node N2;

The first output node setting circuit 13 is electrically connected to the control node NC, the first output node N01 and the first voltage line V1 respectively, and is configured to control the connection between the first output node N01 and the first voltage line V1 under the control of the potential of the control node NC;

The third node control circuit 14 is electrically connected to the first node N1 and the third node N3 respectively, and is configured to control the potential of the third node N3 under the control of the potential of the first node N1;

The first output node control circuit 15 is electrically connected to the third node N3, the second clock signal line CB and the first output node N01 respectively, and is configured to control the connection or disconnection between the third node N3 and the first output node N01 under the control of the second clock signal provided by the second clock signal line CB;

The control node control circuit 16 is electrically connected to the initial control line CX, the first voltage line V1 and the control node NC respectively, and is configured to control the connection or disconnection between the control node NC and the first voltage line V1 under the control of the initial control signal provided by the initial control line CX;

The second output node control circuit 17 is electrically connected to the second output node N02 and the fourth node N4, respectively, and is configured to control the potential of the second output node N02 according to the potential of the fourth node N4;

The first energy storage circuit 18 is electrically connected to the second node N2 and the fourth node N4 respectively, and is configured to store electrical energy;

The output circuit 19 is electrically connected to the first output node N01, the second output node N02 and the driving signal output terminal OT, respectively, is configured to control to output the driving signal under the control of the potential of the first output node N01 and the potential of the second output node N02, and provide the driving signal through the driving signal output terminal OT;

The first on-off control circuit 110 is electrically connected to the second voltage line V2, the control node NC and the second output node N02 respectively, and is configured to control the connection or disconnection between the control node NC and the second output node N02 under the control of the second voltage signal provided by the second voltage line V2.

Optionally, the first voltage line may be a high voltage line, and the second voltage line may be a low voltage line, but is not limited thereto.

At least one embodiment of the driving circuit shown in FIG. 1 may be a GOA (Gate On Array, array substrate row driving) circuit for providing a scanning signal, a GOA circuit for providing a reset control signal, or a GOA circuit for providing a light emitting control signal.

Optionally, the driving circuit further includes a first on-off control circuit; the first on-off control circuit includes a ninth transistor;
a first gate electrode of the ninth transistor is electrically connected to the second voltage line, a first electrode of the ninth transistor is electrically connected to the control node, and a second electrode of the ninth transistor is electrically connected to the second output node;
an orthographic projection of a bottom gate via hole of the ninth transistor on the base substrate and an orthographic projection of the bottom gate via hole of the sixth transistor on the base substrate are arranged along a first direction.

Optionally, the first direction may be a vertical direction, but is not limited thereto.

As shown in FIG. 2, based on at least one embodiment of the driving circuit shown in FIG. 1, the first node control circuit may include a first transistor T1, the second node control circuit includes a second transistor T2; the first output node setting circuit includes a third transistor T3, the first output node control circuit includes a fourth transistor T4; the first energy storage circuit includes a first capacitor C1;

The control node control circuit includes a fifth transistor T5, the second output node control circuit includes a sixth transistor T6; the output circuit includes a seventh transistor T7 and an eighth transistor T8;

The first gate electrode of the first transistor T1 is electrically connected to the first clock signal line CK, the first electrode of the first transistor T1 is electrically connected to the low voltage line VGL, and the second electrode of the first transistor T1 is electrically connected to the first node N1;

A first gate electrode of the second transistor T2 is electrically connected to the first node N1, a first electrode of the second transistor T2 is electrically connected to the high voltage line VGH, and a second electrode of the second transistor T2 is electrically connected to the second node N2;

The first gate electrode of the third transistor T3 is electrically connected to the control node NC, the first electrode of the third transistor T3 is electrically connected to the high voltage line VGH, and the second electrode of the third transistor T3 is electrically connected to the first output node N01;

A first gate electrode of the fourth transistor T4 is electrically connected to the second clock signal line CB, a first electrode of the fourth transistor T4 is electrically connected to the third node N3, and a second electrode of the fourth transistor T4 is electrically connected to the first output node N01;

The first gate electrode of the fifth transistor T5 is electrically connected to the initial control line CX, the first electrode of the fifth transistor T5 is electrically connected to the high voltage line VGH, and the second electrode of the fifth transistor T5 is electrically connected to the control node NC;

The first gate electrode of the sixth transistor T6 and the first electrode of the sixth transistor T6 are electrically connected to the third node N3, and the second electrode of the sixth transistor T6 is electrically connected to the second output node N02;

The first gate electrode of the seventh transistor T7 is electrically connected to the first output node N01, the first electrode of the seventh transistor T7 is electrically connected to the high voltage line VGH, and the second electrode of the seventh transistor T7 is electrically connected to the driving signal output terminal OT;

The first gate electrode of the eighth transistor T8 is electrically connected to the second output node N02, the first electrode of the eighth transistor T8 is electrically connected to the driving signal output terminal OT, and the second electrode of the eighth transistor T8 is electrically connected to the low voltage line VGL;

The first electrode plate of the first capacitor C1 is electrically connected to the second node N2, and the second electrode plate of the first capacitor C1 is electrically connected to the fourth node N4;

The first node control circuit further includes a thirteenth transistor T13; the second node control circuit further includes a fourteenth transistor T14; the first output node control circuit further includes a fifteenth transistor T15, a sixteenth transistor T16 and a second capacitor C2;

The control node control circuit further includes a seventeenth transistor T17;

The second output node control circuit further includes an eighteenth transistor T18 and a nineteenth transistor T19;

The first on-off control circuit includes a ninth transistor T9;

The first gate electrode of the ninth transistor T9 is electrically connected to the low voltage line VGL, the first electrode of the ninth transistor T9 is electrically connected to the control node NC, and the second electrode of the ninth transistor is electrically connected to the second output node N02;

The driving circuit may further include a third capacitor C3;

The first gate electrode of T13 is electrically connected to the control node NC, the first electrode of T13 is electrically connected to the first node N1, and the second electrode of T13 is electrically connected to the first clock signal line CK;

The first gate electrode of T14 is electrically connected to the fourth node N4, the first electrode of T14 is electrically connected to the second node N2, and the second electrode of T14 is electrically connected to the second clock signal line CB;

The first gate electrode of T16 is electrically connected to the low voltage line VGL, the first electrode of T16 is electrically connected to the first node N1, and the second electrode of T16 is electrically connected to the first gate electrode of T15;

A first electrode of T15 is electrically connected to the second clock signal line CB, and a second electrode of T15 is electrically connected to the third node N3;

The first electrode plate of C2 is electrically connected to the first gate electrode of T15, and the second electrode plate of C2 is electrically connected to the third node N3;

The first gate electrode of T17 is electrically connected to the first clock signal line CK, the first electrode of T17 is electrically connected to the input terminal STV, and the second electrode of T17 is electrically connected to the control node NC;

The first gate electrode of T18 is electrically connected to the first clock signal line CK, the first electrode of T18 is electrically connected to the input terminal STV, and the second electrode of T18 is electrically connected to the first electrode of T19;

A first gate electrode of T19 is electrically connected to the low voltage line VGL, and a second electrode of T19 is electrically connected to the fourth node N4;

The first electrode plate of C3 is electrically connected to the gate electrode of T7, and the second electrode plate of C3 is electrically connected to the high voltage line VGH.

In at least one embodiment of the driving circuit shown in FIG. 2, all transistors are p-type transistors, but the present invention is not limited thereto.

In at least one embodiment of the driving circuit shown in FIG. 2, each transistor is a dual-gate transistor, the first gate electrode of each transistor is a top gate electrode, the second gate electrode of each transistor is a bottom gate electrode, and the first gate electrode of each transistor is electrically connected to the second gate electrode of the transistor.

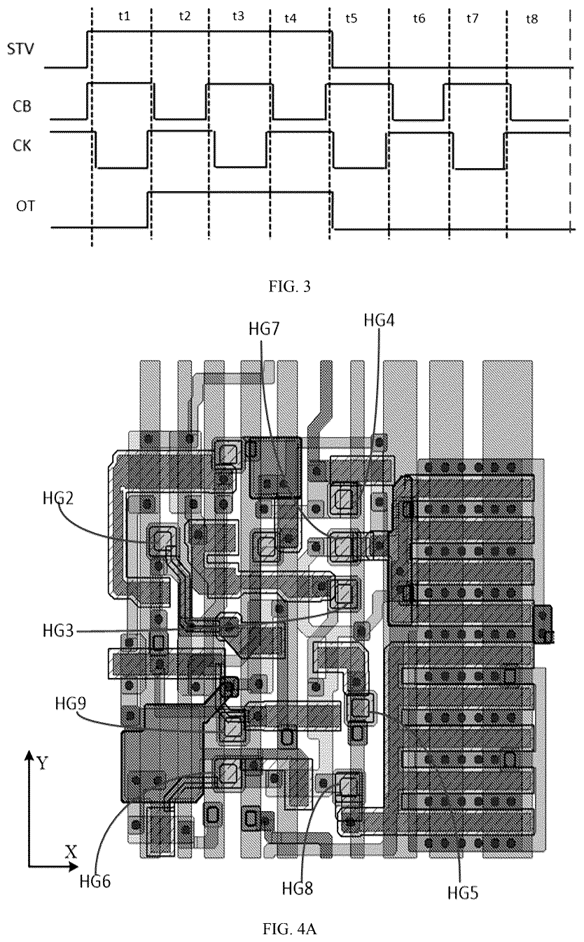

FIG. 3 is the timing diagram of the driving circuit shown in FIG. 2.

As shown in FIG. 3, when one embodiment of the driving circuit shown in FIG. 2 is in operation, In the first time period t1, STV provides a high voltage signal, CK provides a low voltage signal, T17 and T18 are turned on, the potential of NC is high voltage, T13 is turned off, the gate voltage of T6 is high voltage, T14 and T6 are turned off, T1 is turned on, the potential of N1 is low voltage, so that T3 and T8 are turned off, T2 and T15 are turned on; CB provides a high voltage signal, at this time the potential of N3 is high voltage, T4 is turned off. Since the voltage across C3 will not change suddenly, the potential of N01 maintains the high level of the previous frame, T7 is turned off, and the potential of the driving signal output by OT maintains the low level of the previous frame;

In the second time period t2, STV and CK provide high voltage signals, CB provides low voltage signals, T17, T13 and T1 are turned off, the potential of NC remains at a high voltage, the potential of N1 remains at a low voltage, T15 is turned on, the potential of N3 changes from a high voltage to a low voltage, T4 is turned on, the potential of N01 is a low voltage, T7 is turned on and outputs a high level; T17, T14, T6, T3, T8 are turned off, and OT outputs a high voltage signal;

In the third time period t3, STV and CB output high voltage signals, CK provides low voltage, T17 and T18 are turned on, the potential of NC is high voltage, T13 is turned off, the potential of N4 is high voltage, T14 and T6 are turned off, T1 is turned on, the potential of N1 is low voltage, T15 is turned on, the potential of N3 changes from the low voltage of the previous time period to high voltage; T4 is turned off, the potential of N01 maintains low voltage, T7 is turned on and outputs high level; T3 and T8 are turned off, and OT outputs high voltage signals;

In the fourth time period t4, STV and CK provide a high voltage, CB provides a low voltage signal, T17, T18 and T1 are turned off, the potential of NC and the potential of N4 are high, T14 and T6 are turned off, T13 is turned off, the potential of N1 is maintained at a low voltage, T15 is turned on, the potential of N3 jumps to a low level, T4 is turned on, the potential of N01 is a low voltage, T7 is turned on and outputs a high level, T3 and T8 are turned off, and OT outputs a high voltage signal; in order to cooperate with the 3Pulse output of the IC (integrated circuit) signal, the potential of the input signal provided by STV in this period can be converted to a low level, without affecting the overall GOA (Gate On Array, a gate driving circuit set on the array substrate) function;

In the fifth time period t5, STV and CK provide low voltage signals, CB provides high voltage signals, T17 and T18 are turned on, the potential of NC and the potential of N4 become low voltages, T13 and T1 are turned on, the potential of N1 is low voltage, T2 and T15 are turned on, the potential of N2 is high voltage, the potential of N3 becomes high voltage, T4 is turned off, T3 is turned on, the potential of N01 becomes high level, and T7 is turned off; due to the dynamic changes of the potential of N02 and the potential of N4, the potential of N4 is directly affected by C3, the potential drop speed of N02 is greater than the potential drop speed of N4, T6 is turned off, T8 is fully turned on, and OT outputs a low voltage signal;

In the sixth time period t6, STV and CB provide low voltage signals, CK provides high voltage signals, T17, T18 and T1 are turned off, the potential of NC and the potential of N4 are maintained at a low level, T13 is turned on, the potential of N1 and the gate voltage of T15 are at a high level, T2 and T15 are turned off, the potential of N3 is affected by C2 and becomes a high level, T4 and T3 are turned on, the potential of N01 is at a high level, and T7 is turned off; since the potential of N4 is a low voltage, T14 is turned on, the potential of N2 becomes a low voltage, the potential of N4 is affected by C1 and decreases, T6 is turned on, the low voltage state of N02 is maintained, and T8 is ensured to be fully turned on, and OT outputs a low voltage signal;

In the seventh time period t7, STV and CK provide low voltage signals, CB provides high voltage signals, T17, T18, T13 and T1 are turned on, the potentials of NC, N1 and N4 are at low levels, T14 and T2 are turned on, the potential of N2 becomes high, the potential of N4 is pulled up by C1, T6 is turned off; T4 is turned off, T3 is turned on, the potential of N01 is at a high level, T7 is turned off; the potential of NC is pulled down, T9 is turned off, the potential of N02 remains at the low level of the previous frame, T8 is fully turned on, and OT outputs a low voltage signal;

After the sixth time period t7, the seventh time period t7 and the eighth time period t8 are cycled, T3 is continuously turned on, T7 is turned off, T18 and T19 periodically charge C1, T9 and T6 remain turned off, the potential of N02 remains at a low level, T8 continues to be fully turned on and outputs a low level until the next frame of STV signal pulses enters, and the operating state of this level of driving circuit returns to t1 again.

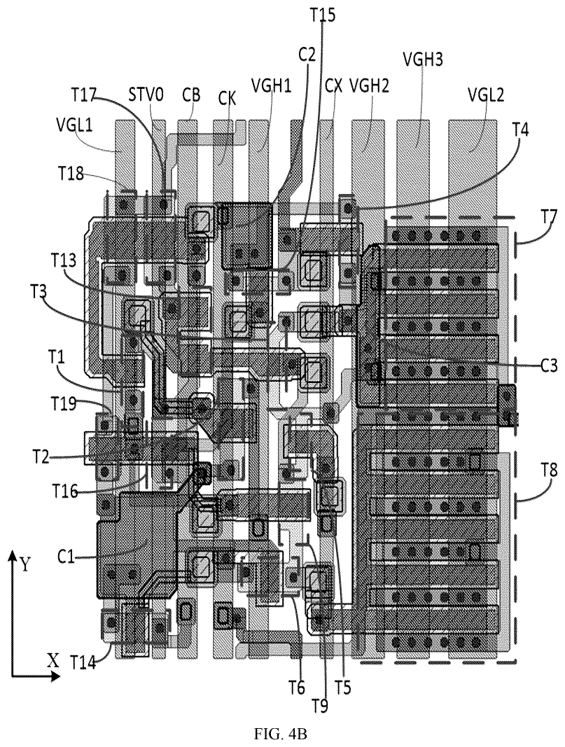

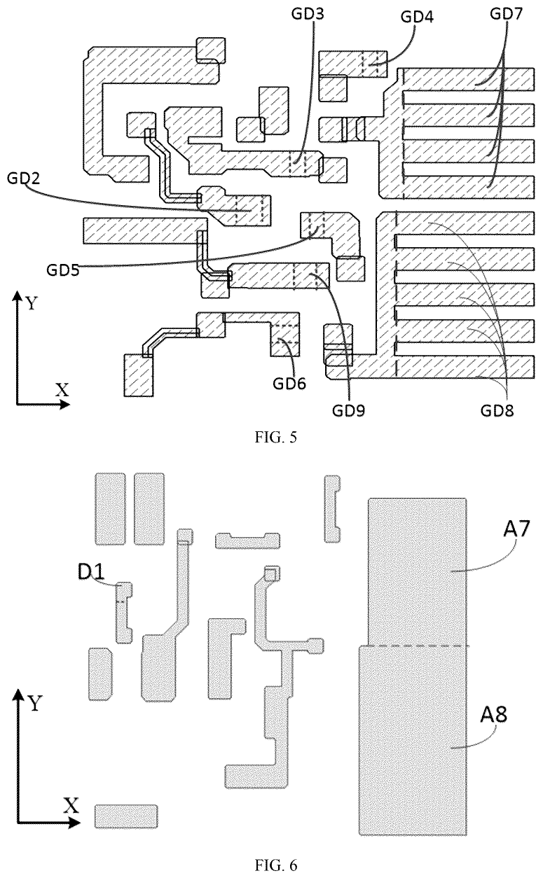

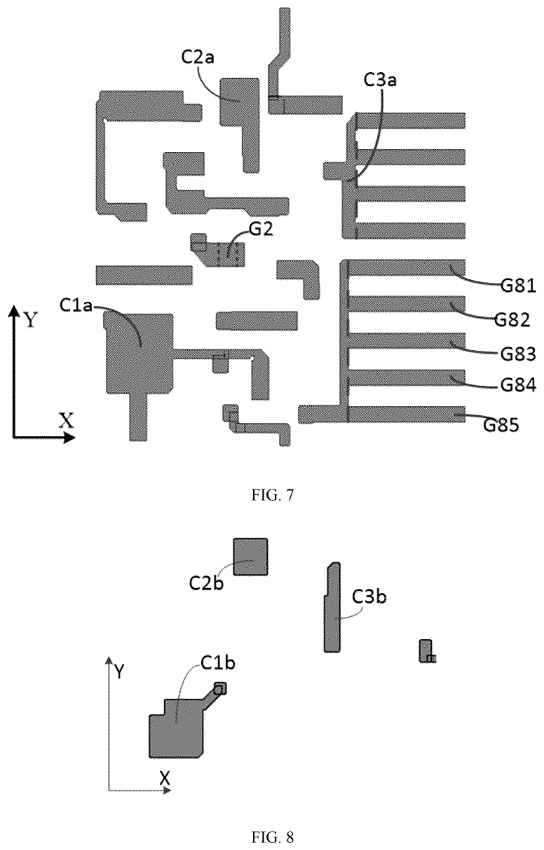

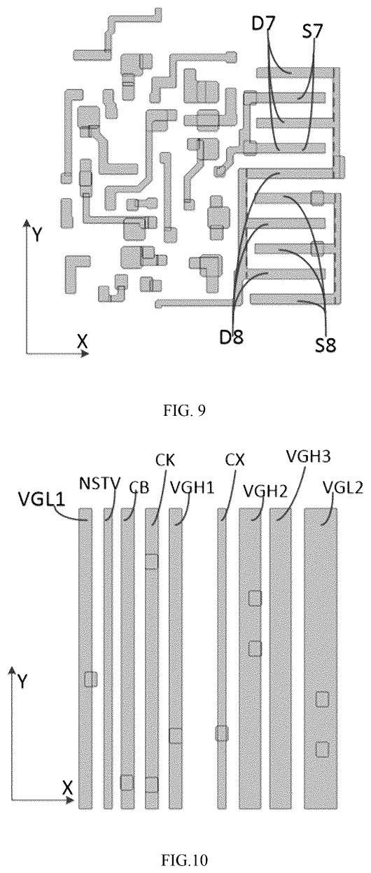

FIGS. 4A and 4B are layout diagrams of the driving circuit shown in FIG. 2. FIG. 5 is a layout diagram of the light shielding metal layer in FIG. 4A, FIG. 6 is a layout diagram of the semiconductor layer in FIG. 4A, FIG. 7 is a layout diagram of the first gate electrode metal layer in FIG. 4A, FIG. 8 is a layout diagram of the second gate electrode metal layer in FIG. 4A, FIG. 9 is a layout diagram of the first source-drain metal layer in FIG. 4A, and FIG. 10 is a layout diagram of the second source-drain metal layer in FIG. 4A.

In FIG. 4A to FIG. 32D, the one labeled Y may be the first direction, and the one labeled X may be the second direction.

In FIG. 4A, the one labeled HG4 is the bottom gate via hole of the fourth transistor, the one labeled HG7 is the bottom gate via hole of the seventh transistor, the one labeled HG3 is the bottom gate via hole of the third transistor, the one labeled HG5 is the bottom gate via hole of the fifth transistor, and the one labeled HG8 is the bottom gate via hole of the eighth transistor;

HG4, HG7, HG3, HG5 and HG8 are arranged in a vertical direction to reduce the lateral space occupied by the driving circuit, thereby facilitating the realization of a narrow frame.

In the specific implementation, HG4, HG7, HG3, HG5 and HG8 are changed from the original left-right tooth arrangement to a vertical arrangement, which utilizes the vertical gaps of the original structure and narrows the space occupied by the driving circuit in the horizontal direction.

In FIG. 4A, the one labeled HG9 is the bottom gate via hole of the ninth transistor T9, and the one labeled HG6 is the bottom gate via hole of the sixth transistor T6;

HG9 and HG6 are arranged in a vertical direction to reduce the lateral space occupied by the driving circuit, thereby facilitating the realization of a narrow frame.

In a specific implementation, the bottom gate via hole HG9 of the ninth transistor T9 and the bottom gate via hole HG6 of the sixth transistor T6 above C1 are arranged vertically instead of being staggered left and right, thereby narrowing the space occupied by the driving circuit in the horizontal direction.

In at least one embodiment of the present disclosure, an orthographic projection of the bottom gate via hole of the second transistor on the base substrate and an orthographic projection of the second electrode of the first transistor on the base substrate are arranged along a first direction.

As shown in FIG. 4A, the one labeled HG2 is the bottom gate via hole of the second transistor, and in FIG. 6, the one labeled D1 is the second electrode of the first transistor T1;

As shown in FIGS. 4A to 10, the orthographic projection of HG2 on the base substrate and the orthographic projection of D1 on the base substrate are arranged in the vertical direction, and the first gate electrode G2 of the second transistor T2 and the second gate electrode GD2 of the second transistor are electrically connected to the second electrode D1 of the first transistor T1.

In specific implementation, the bottom gate via hole of T2 is moved up to the gap above the second electrode D1 of T1, thereby compressing the horizontal space on the left side of T2, reducing the length of the transfer hole connection while avoiding the transistor structure, and compressing the layout space.

In at least one embodiment of the present disclosure, a length of an orthographic projection of the first capacitor on the base substrate along the second direction is less than a second length threshold.

In a specific implementation, the length of the orthographic projection of the first capacitor on the base substrate along the second direction is set to be smaller, that is, the length of the first electrode plate of the first capacitor along the second direction is set to be smaller, and the length of the second electrode plate of the first capacitor along the second direction is set to be smaller, so as to narrow the lateral space occupied by the first capacitor.

In FIG. 4B, the first capacitor is labeled C1, in FIG. 7, the first electrode plate of C1 is labeled C1a, and in FIG. 8, the second electrode plate of C1 is labeled C1b;

The lengths of C1a and C1b in the horizontal direction are set to be smaller, and the shape of C1 is changed, so that its vertical height is increased and its width is narrowed, which is conducive to the close arrangement of devices in the horizontal direction.

Optionally, a length of the active pattern of the eighth transistor along the second direction is smaller than a first length threshold.

As shown in FIG. 6, the one labeled A8 is the active pattern of the eighth transistor T8, and the length of A8 along the horizontal direction is set to be smaller, thereby narrowing the space occupied by T8 in the horizontal direction.

As shown in FIG. 7, the first gate electrode pattern labeled G81 is included in the first gate electrode of T8, the second gate electrode pattern labeled G82 is included in the first gate electrode of T8, the third gate pattern labeled G83 is included in the first gate electrode of T8, the fourth gate pattern labeled G84 is included in the first gate electrode of T8, and the fifth gate pattern labeled G85 is included in the first gate electrode of T8;

By increasing the number of gate patterns included in the gate electrode of T8, it is possible to reduce the space of the active pattern A8 of T8 in the horizontal direction while ensuring that the channel width of T8 remains unchanged. For example, the width of the active pattern of T8 in the horizontal direction can be reduced from 43 μm to 34.4 μm, thereby narrowing the space occupied by T8 in the horizontal direction.

In FIG. 4B, the starting voltage line is labeled STV0, the first low voltage line is labeled VGL1, the second clock signal line is labeled CB, the first clock signal line is labeled CK, the first high voltage line is labeled VGH1, the initial control line is labeled CX, the second high voltage line is labeled VGH2, the third high voltage line is labeled VGH3, and the second low voltage line is labeled VGL2.

In FIG. 5, the second gate electrode of T2 is labeled GD2, the second gate electrode of T3 is labeled GD3, the second gate electrode of T3 is labeled GD4, the second gate electrode of T4 is labeled GD5, the second gate electrode of T5 is labeled GD5, the second gate electrode of T6 is labeled GD6, the second gate electrode of T7 is labeled GD7, the second gate electrode of T8 is labeled GD8, and the second gate electrode of T9 is labeled GD9.

In FIG. 6, A7 is an active pattern of T7, and A8 is an active pattern of T8.

In FIG. 7, C1a is the first electrode plate of C1, C2a is the first electrode plate of C2, and C3a is the first electrode plate of C3.

In FIG. 8, the one labeled C1b is the second electrode plate of C1, the one labeled C2b is the second electrode plate of C2, and the one labeled C3b is the second electrode plate of C3.

In FIG. 9, S7 is the first electrode of T7, and D7 is the second electrode of T7; S8 is the first electrode of T8, and D8 is the second electrode of T8.

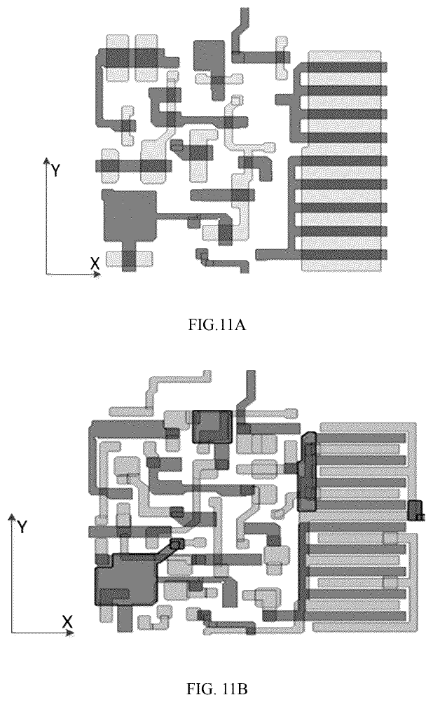

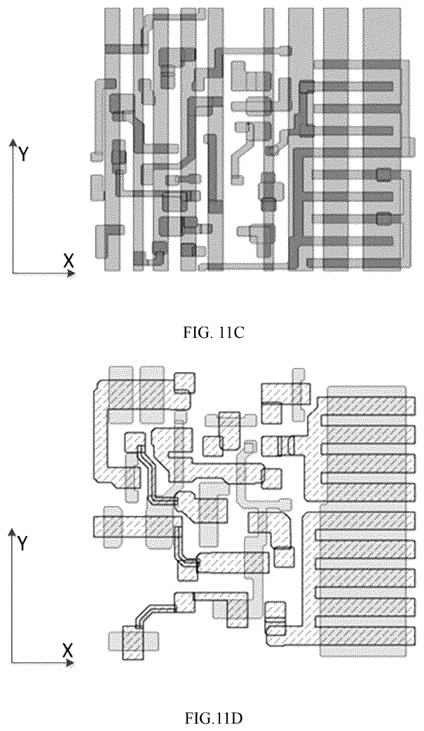

FIG. 11A is a schematic diagram of the superposition of the semiconductor layer and the first gate electrode metal layer in FIG. 4A, FIG. 11B is a schematic diagram of the superposition of the first gate electrode metal layer, the second gate electrode metal layer and the first source and drain metal layer in FIG. 4A, FIG. 11C is a schematic diagram of the superposition of the first source-drain metal layer and the second source-drain metal layer in FIG. 4A, and FIG. 11D is a schematic diagram of the superposition of the light shielding metal layer and the semiconductor layer in FIG. 4A.

In at least one embodiment of the present disclosure, the driving circuit includes a first node control circuit, a second node control circuit, a third node control circuit, a first output node control circuit, a first output node setting circuit, a control node control circuit, an output circuit, a first energy storage circuit, a second energy storage circuit, and a third energy storage circuit;

The first node control circuit is electrically connected to the first node and is configured to control the potential of the first node;

The first output node setting circuit is electrically connected to the control node, the first output node and the first voltage line respectively, and is configured to control the connection between the first output node and the first voltage line under the control of the potential of the control node;

The third node control circuit is electrically connected to the fifth node and the third node respectively, and is configured to control the potential of the third node under the control of the potential of the fifth node;

The first output node control circuit is electrically connected to the third node, the second clock signal line and the first output node respectively, and is configured to control the connection or disconnection between the third node and the first output node under the control of the second clock signal provided by the second clock signal line;

The control node control circuit is electrically connected to the input terminal, the first clock signal line, the initial control line, the first voltage line and the control node respectively, and is configured to control the connection or disconnection between the control node and the first voltage line under the control of the initial control signal provided by the initial control line, and control the connection or disconnection between the control node and the input terminal under the control of the first clock signal provided by the first clock signal line;

The first energy storage circuit is electrically connected to the second node and the second output node respectively, and is configured to store electrical energy;

A first terminal of the second energy storage circuit is electrically connected to the first node, a second terminal of the second energy storage circuit is electrically connected to the third node, and the second energy storage circuit is configured to store electrical energy;

The third energy storage circuit is electrically connected to the first output node and is configured to maintain the potential of the first output node;

The output circuit is electrically connected to the first output node, the second output node and the driving signal output terminal respectively, and is configured to control to output the driving signal under the control of the potential of the first output node and the potential of the second output node, and provide the driving signal through the driving signal output terminal.

Optionally, the first node may be directly electrically connected to the fifth node, and the control node may be directly electrically connected to the second output node, but the present disclosure is not limited thereto.

In a specific implementation, at least one embodiment of the driving circuit may further include a first on-off control circuit and a second on-off control circuit;

The first on-off control circuit is electrically connected to the second voltage line, the control node and the second output node respectively, and is configured to control the connection between the control node and the second output node under the control of the second voltage signal provided by the second voltage line;

The second on-off control circuit is electrically connected to the second voltage line, the first node and the fifth node respectively, and is configured to control the connection between the first node and the fifth node under the control of the second voltage signal provided by the second voltage line.

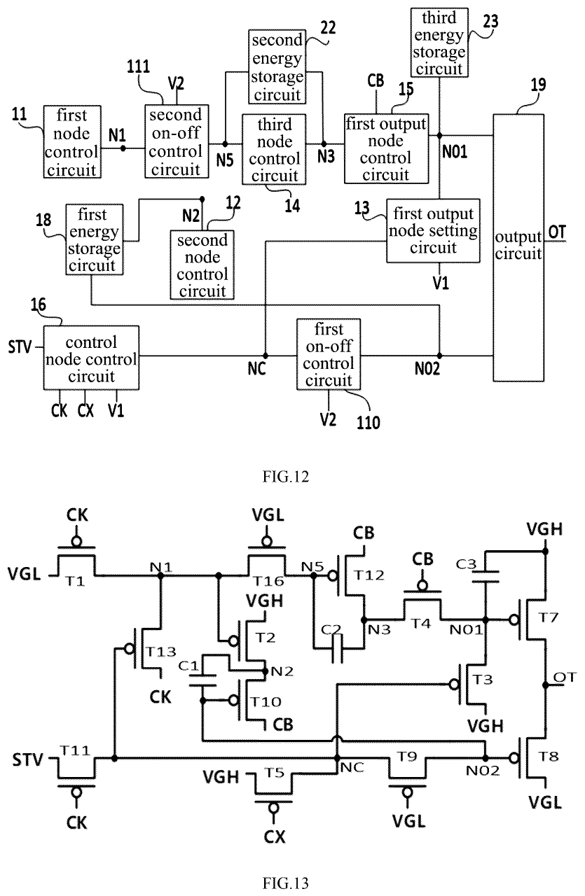

As shown in FIG. 12, at least one embodiment of the driving circuit includes a first node control circuit 11, a second node control circuit 12, a third node control circuit 14, a first output node control circuit 15, a first output node setting circuit 13, a control node control circuit 16, an output circuit 19, a first energy storage circuit 18, a second energy storage circuit 22, a third energy storage circuit 23, a first on-off control circuit 110, and a second on-off control circuit 111;

The first node control circuit 11 is electrically connected to the first node N1 and is configured to control the potential of the first node N1;

The second node control circuit 12 is electrically connected to the second node N2, and is configured to control the potential of the second node N2;

The first output node setting circuit 13 is electrically connected to the control node NC, the first output node N01 and the first voltage line V1 respectively, and is configured to control the connection between the first output node N01 and the first voltage line V1 under the control of the potential of the control node NC;

The third node control circuit 14 is electrically connected to the fifth node N5 and the third node N3, respectively, and is configured to control the potential of the third node N3 under the control of the potential of the fifth node N5;

The first output node control circuit 15 is electrically connected to the third node N3, the second clock signal line CB and the first output node N01 respectively, and is configured to control the connection or disconnection between the third node N3 and the first output node N01 under the control of the second clock signal provided by the second clock signal line CB;

The control node control circuit 16 is electrically connected to the input terminal STV, the first clock signal line CK, the initial control line CX, the first voltage line V1 and the control node NC, respectively, and is configured to control the connection or disconnection between the control node NC and the first voltage line V1 under the control of the initial control signal provided by the initial control line CX, and control the connection or disconnection between the control node NC and the input terminal STV under the control of the first clock signal provided by the first clock signal line CK;

The first energy storage circuit 18 is electrically connected to the second node N2 and the second output node N02 respectively, and is configured to store electrical energy;

The first terminal of the second energy storage circuit 22 is electrically connected to the fifth node N5, the second terminal of the second energy storage circuit 22 is electrically connected to the third node N3, and the second energy storage circuit 22 is configured to store electrical energy;

The third energy storage circuit 23 is electrically connected to the first output node N01, and is configured to maintain the potential of the first output node N01;

The output circuit 19 is electrically connected to the first output node N01, the second output node N02 and the driving signal output terminal OT respectively, and is configured to control to output the driving signal under the control of the potential of the first output node N01 and the potential of the second output node N02, and provide the driving signal through the driving signal output terminal OT;

The first on-off control circuit 110 is electrically connected to the second voltage line V2, the control node NC and the second output node N02 respectively, and is configured to control the connection between the control node NC and the second output node N02 under the control of the second voltage signal provided by the second voltage line V2;

The second on-off control circuit 111 is electrically connected to the second voltage line V2, the first node N1 and the fifth node N5 respectively, and is configured to control the connection between the first node N1 and the fifth node N5 under the control of the second voltage signal provided by the second voltage line V2.

Optionally, the first node control circuit includes a first transistor and a thirteenth transistor, and the second node control circuit includes a second transistor and a tenth transistor; the first output node setting circuit includes a third transistor, and the first output node control circuit includes a fourth transistor; the first energy storage circuit includes a first capacitor; the second energy storage circuit includes a second capacitor, and the third energy storage circuit includes a third capacitor; the control node control circuit includes a fifth transistor and an eleventh transistor, and the output circuit includes a seventh transistor and an eighth transistor; the third node control circuit includes a twelfth transistor;

A first gate electrode of the first transistor is electrically connected to a first clock signal line, a first electrode of the first transistor is electrically connected to a second voltage line, and a second electrode of the first transistor is electrically connected to the first node;
a first gate electrode of the thirteenth transistor is electrically connected to the control node, a first electrode of the thirteenth transistor is electrically connected to the first clock signal line, and a second electrode of the thirteenth transistor is electrically connected to the first node;

A first gate electrode of the second transistor is electrically connected to the first node, a first electrode of the second transistor is electrically connected to a first voltage line, and a second electrode of the second transistor is electrically connected to the second node;

A first gate electrode of the tenth transistor is electrically connected to the second output node, a first electrode of the tenth transistor is electrically connected to the second clock signal line, and a second electrode of the tenth transistor is electrically connected to the second node;

A first gate electrode of the third transistor is electrically connected to the control node, a first electrode of the third transistor is electrically connected to a first voltage line, and a second electrode of the third transistor is electrically connected to the first output node;

A first gate electrode of the fourth transistor is electrically connected to the second clock signal line, a first electrode of the fourth transistor is electrically connected to the third node, and a second electrode of the fourth transistor is electrically connected to the first output node;
a first gate electrode of the fifth transistor is electrically connected to the initial control line, a first electrode of the fifth transistor is electrically connected to the first voltage line, and a second electrode of the fifth transistor is electrically connected to the control node;
a first gate electrode of the eleventh transistor is electrically connected to the first clock signal line, a first electrode of the eleventh transistor is electrically connected to the input terminal, and a second electrode of the eleventh transistor is electrically connected to the control node;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second voltage line;
a first gate electrode of the twelfth transistor is electrically connected to the first node, a first electrode of the twelfth transistor is electrically connected to the second clock signal line, and a second electrode of the twelfth transistor is electrically connected to the third node;
a first electrode plate of the first capacitor is electrically connected to the second node, and a second electrode plate of the first capacitor is electrically connected to the second output node;
a first electrode plate of the second capacitor is electrically connected to the first node, and a second electrode plate of the second capacitor is electrically connected to the third node;
a first electrode plate of the third capacitor is electrically connected to the first output node, and a second electrode plate of the third capacitor is electrically connected to the first voltage line.

As shown in FIG. 13, based on one embodiment of the driving circuit shown in FIG. 12, the first node control circuit includes a first transistor T1 and a thirteenth transistor T13, the second node control circuit includes a second transistor T2 and a tenth transistor T10; the first output node setting circuit includes a third transistor T3, and the first output node control circuit includes a fourth transistor T4; the first energy storage circuit includes a first capacitor C1; the second energy storage circuit includes a second capacitor C2, and the third energy storage circuit includes a third capacitor C3; the control node control circuit includes a fifth transistor T5 and an eleventh transistor T11, and the output circuit includes a seventh transistor T7 and an eighth transistor T8; the third node control circuit includes a twelfth transistor T12;

The first gate electrode of the first transistor T1 is electrically connected to the first clock signal line CK, the first electrode of the first transistor T1 is electrically connected to the low voltage line VGL, and the second electrode of the first transistor T1 is electrically connected to the first node N1;

The first gate electrode of the thirteenth transistor T13 is electrically connected to the control node NC, the first electrode of the thirteenth transistor T13 is electrically connected to the first clock signal line CK, and the second electrode of the thirteenth transistor T13 is electrically connected to the first node N1;

The first gate electrode of the second transistor T2 is electrically connected to the first node N1, the first electrode of the second transistor T2 is electrically connected to the high voltage line VGH, and the second electrode of the second transistor T2 is electrically connected to the second node N2;

The first gate electrode of the tenth transistor T10 is electrically connected to the second output node N02, the first electrode of the tenth transistor T10 is electrically connected to the second clock signal line CB, and the second electrode of the tenth transistor T10 is electrically connected to the second node N2;

The first gate electrode of the third transistor T3 is electrically connected to the control node NC, the first electrode of the third transistor T3 is electrically connected to the high voltage line VGH, and the second electrode of the third transistor T3 is electrically connected to the first output node N01;

A first gate electrode of the fourth transistor T4 is electrically connected to the second clock signal line CB, a first electrode of the fourth transistor T4 is electrically connected to the third node N3, and a second electrode of the fourth transistor T4 is electrically connected to the first output node N01;

The first gate electrode of the fifth transistor T5 is electrically connected to the initial control line CX, the first electrode of the fifth transistor T5 is electrically connected to the high voltage line VGH, and the second electrode of the fifth transistor T5 is electrically connected to the control node NC;
a first gate electrode of the eleventh transistor T11 is electrically connected to the first clock signal line CK, a first electrode of the eleventh transistor T11 is electrically connected to the input terminal STV, and a second electrode of the eleventh transistor T11 is electrically connected to the control node NC;

The first gate electrode of the seventh transistor T7 is electrically connected to the first output node N01, the first electrode of the seventh transistor T7 is electrically connected to the high voltage line VGH, and the second electrode of the seventh transistor T7 is electrically connected to the driving signal output terminal OT;

The first gate electrode of the eighth transistor T8 is electrically connected to the second output node N02, the first electrode of the eighth transistor T8 is electrically connected to the driving signal output terminal OT, and the second electrode of the eighth transistor T8 is electrically connected to the low voltage line VGL;

The first gate electrode of the twelfth transistor T12 is electrically connected to the first node N1, the first electrode of the twelfth transistor T12 is electrically connected to the second clock signal line CB, and the second electrode of the twelfth transistor T12 is electrically connected to the third node N3;

The first electrode plate of the first capacitor C1 is electrically connected to the second node N2, and the second electrode plate of the first capacitor C1 is electrically connected to the second output node N02;

The first electrode plate of the second capacitor C2 is electrically connected to the fifth node N5, and the second electrode plate of the second capacitor C2 is electrically connected to the third node N3;

The first electrode plate of the third capacitor C3 is electrically connected to the first output node N01, and the second electrode plate of the third capacitor C3 is electrically connected to the high voltage line VGH;

The first on-off control circuit includes a ninth transistor T9, and the second on-off control circuit includes a sixteenth transistor T16;

The first gate electrode of the ninth transistor T9 is electrically connected to the low voltage line VGL, the first electrode of the ninth transistor T9 is electrically connected to the control node NC, and the second electrode of the ninth transistor T9 is electrically connected to the second output node N02;

A first gate electrode of the sixteenth transistor T16 is electrically connected to the low voltage line VGL, a first electrode of the sixteenth transistor T16 is electrically connected to the first node N1, and a second electrode of the sixteenth transistor T16 is electrically connected to the fifth node N5.

In one embodiment of the driving circuit shown in FIG. 13, all transistors are p-type transistors, but the present invention is not limited thereto.

In at least one embodiment of the present disclosure, the orthographic projection of the electrode plate of the second capacitor on the base substrate is at least partially arranged around the orthographic projection of the bottom gate via hole of the eleventh transistor on the base substrate.

Optionally, the electrode plates of the second capacitor include a first electrode plate of the second capacitor and a second electrode plate of the second capacitor.

In a specific implementation, the shape of the electrode plate of the second capacitor can be changed to be vertically stretched and surround the bottom gate via hole of the eleventh transistor, and the orthographic projection of the electrode plate of the second capacitor on the base substrate is set to at least partially surround the orthographic projection of the bottom gate via hole of the eleventh transistor on the base substrate to reduce the width of the driving circuit in the horizontal direction.

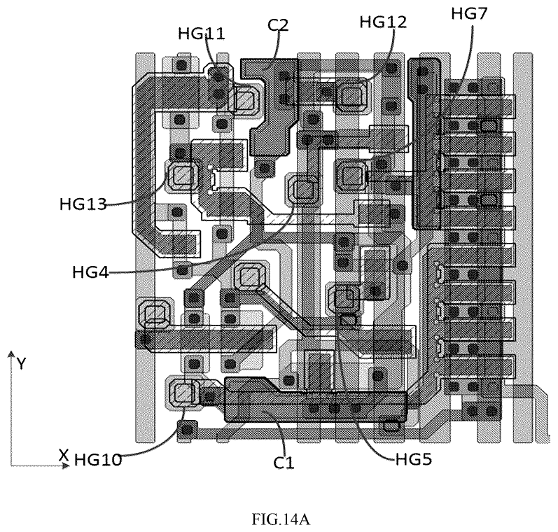

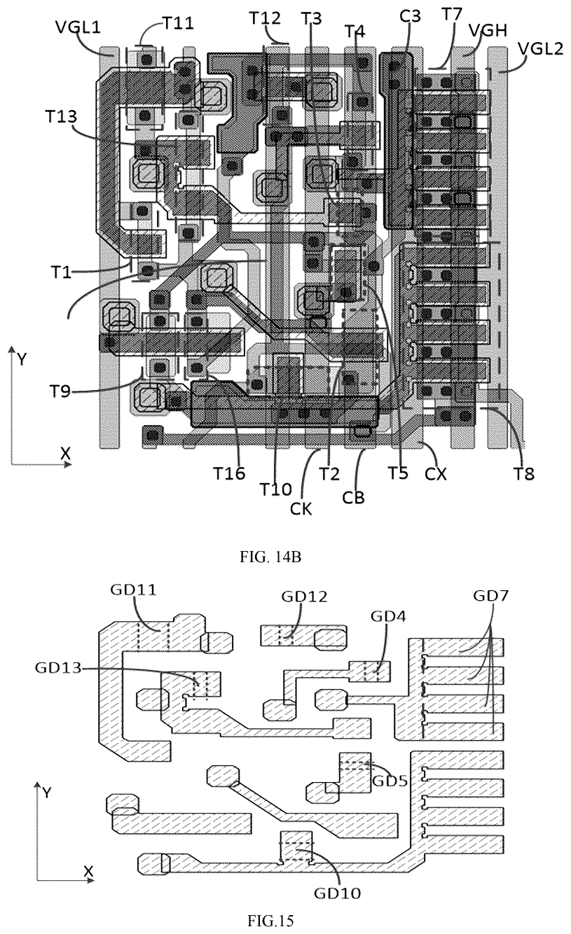

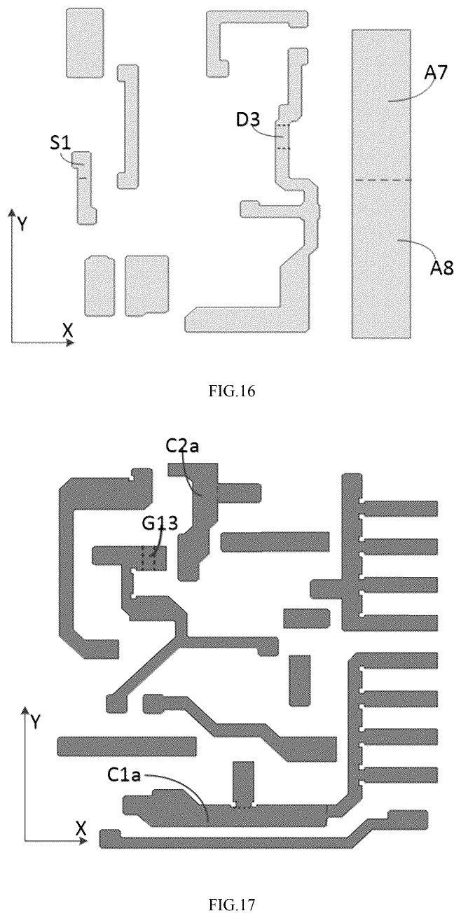

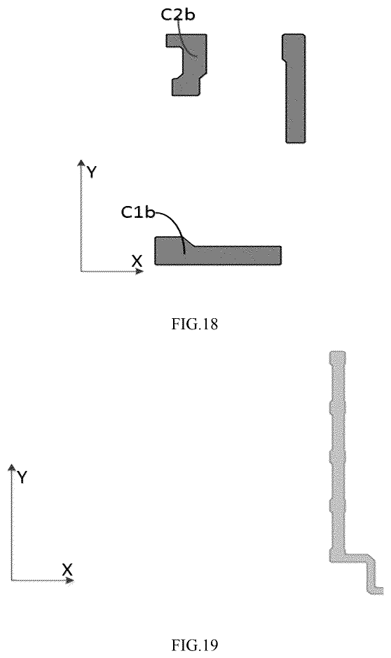

FIGS. 14A and 14B are layout diagrams of at least one embodiment of the driving circuit shown in FIG. 13, FIG. 15 is a layout diagram of the light shielding metal layer in FIG. 14A, FIG. 16 is a layout diagram of the semiconductor layer in FIG. 14A, FIG. 17 is a layout diagram of the first gate electrode metal layer in FIG. 14A, FIG. 18 is a layout diagram of the second gate electrode metal layer in FIG. 14A, FIG. 19 is a layout diagram of the third gate metal layer in FIG. 14A, FIG. 20 is a layout diagram of the first source-drain metal layer in FIG. 14A, and FIG. 21 is a layout diagram of the second source-drain metal layer in FIG. 14A.

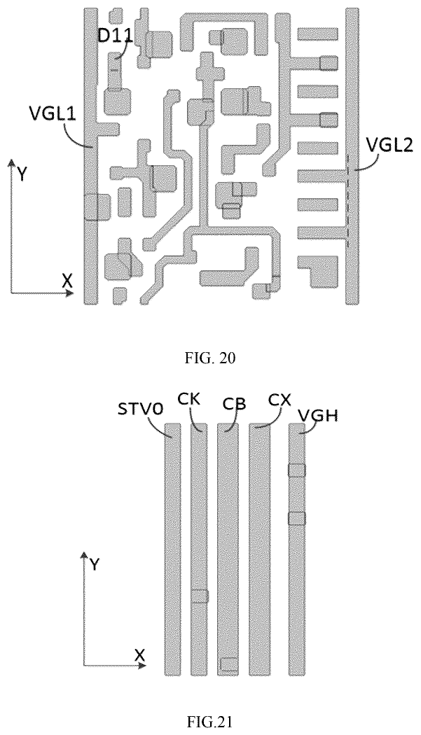

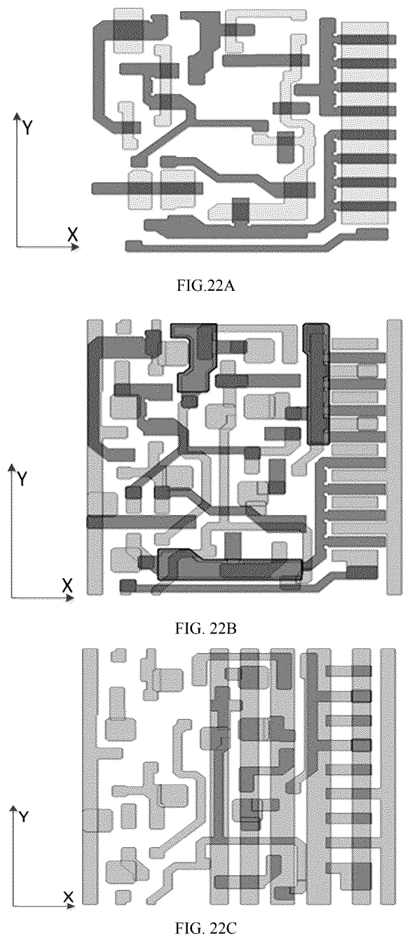

FIG. 22A is a schematic diagram of the superposition of the semiconductor layer and the first gate electrode metal layer in FIG. 14A, FIG. 22B is a schematic diagram of the superposition of the first gate electrode metal layer, the second gate electrode metal layer and the first source and drain metal layer in FIG. 14A, FIG. 22C is a layout diagram of the first source-drain metal layer and the second source-drain metal layer in FIG. 14A, and FIG. 22D is a layout diagram of the light shielding metal layer and the semiconductor layer in FIG. 14A.

As shown in FIG. 17, C2a is the first electrode plate of the second capacitor C2, as shown in FIG. 18, C2b is the second electrode plate of the second capacitor C2, and in FIG. 14A, HG11 is the bottom gate via hole of the eleventh transistor T11.

In at least one embodiment of the present disclosure, an orthographic projection of the second electrode of the eleventh transistor on the base substrate and an orthographic projection of the bottom gate via hole of the thirteenth transistor on the base substrate are arranged along a first direction.

In FIG. 14A, HG13 is the bottom gate via hole of the thirteenth transistor T13, in FIG. 20, D11 is the second electrode of the eleventh transistor T11, as shown in FIG. 17, G13 is the first gate electrode of T13; as shown in FIGS. 14A to 21, the first gate electrode G13 of the thirteenth transistor T13 is electrically connected to the second electrode of the eleventh transistor T11.

As shown in FIG. 14A to FIG. 21, D11 and HG13 are arranged in the vertical direction to reduce the lateral space occupied by the driving circuit and reduce the length of the transfer hole connection while avoiding the transistor structure, thereby compressing the layout space.

In at least one embodiment of the present disclosure, an orthographic projection of the bottom gate via hole of the thirteenth transistor on the base substrate and an orthographic projection of the first electrode of the first transistor on the base substrate are arranged along a first direction.

In a specific implementation, the orthographic projection of the bottom gate via hole of the thirteenth transistor on the base substrate and the orthographic projection of the first electrode of the first transistor on the base substrate are arranged along a first direction to reduce the lateral space occupied by the driving circuit, thereby facilitating the realization of a narrow frame.

As shown in FIG. 14A, the one labeled HG13 is the bottom gate via hole of the thirteenth transistor T13, and as shown in FIG. 16, the one labeled S1 is the first electrode of the first transistor.

The orthographic projection of HG13 on the base substrate and the orthographic projection of S1 on the base substrate are arranged in a vertical direction to reduce the lateral space occupied by the driving circuit, which is conducive to achieving a narrow frame.

In at least one embodiment of the present disclosure, the orthographic projection of the bottom gate via hole of the twelfth transistor on the base substrate, the orthographic projection of the bottom gate via hole of the seventh transistor on the base substrate and the orthographic projection of the bottom gate via hole of the fifth transistor on the base substrate are arranged along a first direction.

In a specific implementation, the orthographic projection of the bottom gate via hole of the twelfth transistor on the base substrate, the orthographic projection of the bottom gate via hole of the seventh transistor on the base substrate, and the orthographic projection of the bottom gate via hole of the fifth transistor on the base substrate are arranged along a first direction to reduce the lateral space occupied by the driving circuit, thereby facilitating the realization of a narrow frame.

As shown in FIG. 14A, the one labeled HG12 is the bottom gate via hole of the twelfth transistor T12, the one labeled HG7 is the bottom gate via hole of the seventh transistor T7, and the one labeled HG5 is the bottom gate via hole of the fifth transistor T5;

HG12, HG7 and HG5 are arranged in a vertical direction to reduce the lateral space occupied by the driving circuit, thereby facilitating the realization of a narrow frame.

In at least one embodiment of the present disclosure, an orthographic projection of the bottom gate via hole of the fourth transistor on the base substrate and an orthographic projection of the second electrode of the third transistor on the base substrate are arranged along a second direction.

In a specific implementation, the bottom gate via hole of the fourth transistor is inserted into the left space of the third transistor, which can compress the horizontal space and facilitate the realization of a narrow frame.

As shown in FIG. 14A, the one labeled HG4 is the bottom gate via hole of the fourth transistor, and as shown in FIG. 16, the second electrode of the third transistor T3 is labeled D3;

As shown in FIG. 14A to FIG. 21, HG4 and D3 are arranged in the horizontal direction, and HG4 is set in the space on the left side of D3 to compress the horizontal space.

In at least one embodiment of the present disclosure, an orthographic projection of the bottom gate via hole of the tenth transistor on the base substrate and an orthographic projection of the electrode plate of the first capacitor on the base substrate are arranged along the second direction.

Optionally, the electrode plates of the first capacitor include a first electrode plate of the first capacitor and a second electrode plate of the first capacitor.

In a specific implementation, the shape of the first capacitor can be stretched horizontally, and the bottom gate via hole of the tenth transistor can be set on the left side of the first capacitor, which can reduce the horizontal space occupied by the bottom gate via hole on the left side of the eighth transistor.

As shown in FIG. 14A, the one labeled HG10 is the bottom gate via hole of the tenth transistor T10, and the one labeled C1 is the first capacitor.

As shown in FIG. 17, C1a is the first electrode plate of the first capacitor C1, and as shown in FIG. 18, C1b is the second electrode plate of the first capacitor C1.

As shown in FIG. 14A to FIG. 21, the orthographic projection of HG10 on the base substrate and the orthographic projection of C1a on the base substrate are arranged in the horizontal direction.

Optionally, a length of the active pattern of the eighth transistor along the second direction is smaller than a first length threshold.

In FIG. 16, the one labeled A8 is the active pattern of the eighth transistor T8;

In a specific implementation, the length of the active pattern A8 of the eighth transistor T8 in the horizontal direction may be set to be smaller, so as to narrow the lateral space occupied by the driving circuit.

In FIG. 14B, VGL1 is a first low voltage line, CK is a first clock signal line, CB is a second clock signal line, CX is an initial control line, VGH is a high voltage line, and VGL2 is a second low voltage line.

In FIG. 15, the one labeled GD4 is the second gate electrode of T4, the one labeled GD5 is the second gate electrode of T5, the one labeled GD7 is the second gate electrode of T7, the one labeled GD10 is the second gate electrode of T10, the one labeled GD11 is the second gate electrode of T11, the one labeled GD12 is the second gate electrode of T12, and the one labeled GD13 is the second gate electrode of T13.

In FIG. 16, A7 is an active pattern of T7, and A8 is an active pattern of T8.

In at least one embodiment of the present disclosure, the driving circuit includes a first output node control circuit, a sixth node control circuit, a second output node control circuit, and an output circuit;

The first output node control circuit is configured to control the potential of the first output node;

The sixth node control circuit is configured to control the potential of the sixth node;

The second output node control circuit is configured to control the potential of the second output node according to the potential of the sixth node;

The output circuit is used for controlling the potential of the first output node and the potential of the second output node to provide a driving signal through the driving signal output terminal.

In a specific implementation, the driving circuit may include a first output node control circuit, a sixth node control circuit, a second output node control circuit and an output circuit; the first output node control circuit controls the potential of the first output node; the sixth node control circuit controls the potential of the sixth node; the second output node control circuit controls the potential of the second output node according to the potential of the sixth node; the output circuit controls to provide a driving signal through a driving signal output terminal at the potential of the first output node and the potential of the second output node.

As shown in FIG. 23, one embodiment of the driving circuit includes a first output node control circuit 15, a sixth node control circuit 31, a second output node control circuit 17, and an output circuit 19;

The first output node control circuit 15 is electrically connected to the first output node N01 and is configured to control the potential of the first output node N01;

The sixth node control circuit 31 is electrically connected to the sixth node N6, and is configured to control the potential of the sixth node N6;

The second output node control circuit is electrically connected to the sixth node N6 and the second output node N02 respectively, and is configured to control the potential of the second output node N02 according to the potential of the sixth node N6;

The output circuit 19 is electrically connected to the first output node N01, the second output node N02 and the driving signal output terminal OT respectively, and is configured to control to provide the driving signal through the driving signal output terminal OT at the potential of the first output node N01 and the potential of the second output node N02.

Optionally, the first output node control circuit includes a first transistor and a ninth transistor;

A first gate electrode of the first transistor is electrically connected to a first clock signal line, a first electrode of the first transistor is electrically connected to a second voltage line, and a second electrode of the first transistor is electrically connected to the first output node;
a first gate electrode of the ninth transistor is electrically connected to the sixth node, a first electrode of the ninth transistor is electrically connected to the first clock signal line, and a second electrode of the ninth transistor is electrically connected to the first output node;

The sixth node control circuit includes an eleventh transistor, a fourteenth transistor and a fifteenth transistor;
a first gate electrode of the eleventh transistor is electrically connected to the first clock signal line, a first electrode of the eleventh transistor is electrically connected to the input terminal, and a second electrode of the eleventh transistor is electrically connected to the sixth node;

A first gate electrode of the fourteenth transistor is electrically connected to the first output node, a first electrode of the fourteenth transistor is electrically connected to the first voltage line, and a second electrode of the fourteenth transistor is electrically connected to the first electrode of the fifteenth transistor;
a first gate electrode of the fifteenth transistor is electrically connected to the second clock signal line, and a second electrode of the fifteenth transistor is electrically connected to the sixth node;

The second output node control circuit includes a sixteenth transistor;
a first gate electrode of the sixteenth transistor is electrically connected to the second voltage line, a first electrode of the sixteenth transistor is electrically connected to the sixth node, and a second electrode of the sixteenth transistor is electrically connected to the second output node;

The output circuit includes a seventh transistor and an eighth transistor;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second clock signal line.

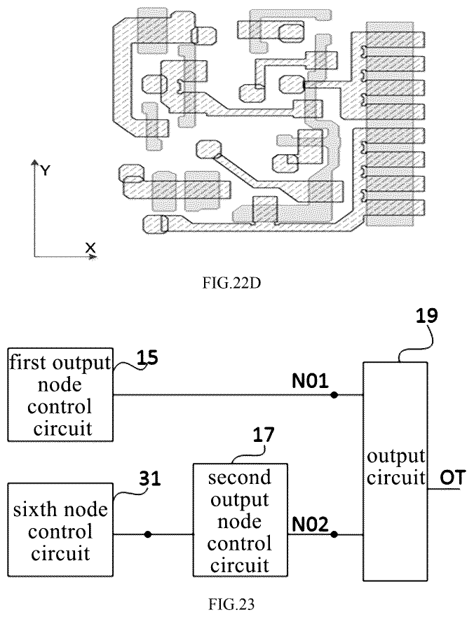

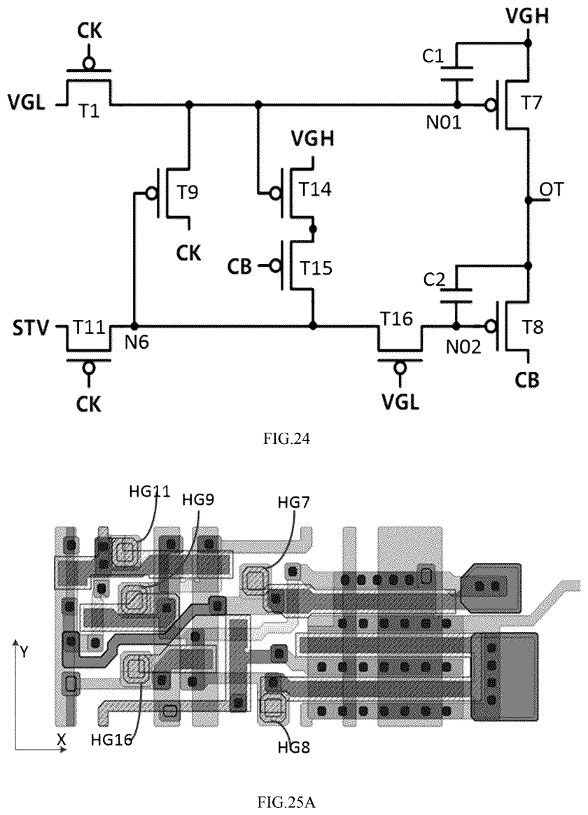

As shown in FIG. 24, based on at least one embodiment of the driving circuit shown in FIG. 23, the first output node control circuit includes a first transistor T1 and a ninth transistor T9;

The first gate electrode of the first transistor T1 is electrically connected to the first clock signal line CK, the first electrode of the first transistor T1 is electrically connected to the low voltage line VGL, and the second electrode of the first transistor T1 is electrically connected to the first output node N01;

The first gate electrode of the ninth transistor T9 is electrically connected to the sixth node N6, the first electrode of the ninth transistor T9 is electrically connected to the first clock signal line CK, and the second electrode of the ninth transistor T9 is electrically connected to the first output node N01;

The sixth node control circuit includes an eleventh transistor T11, a fourteenth transistor T14 and a fifteenth transistor T15;

The first gate electrode of the eleventh transistor T11 is electrically connected to the first clock signal line CK, the first electrode of the eleventh transistor T11 is electrically connected to the input terminal STV, and the second electrode of the eleventh transistor T11 is electrically connected to the sixth node N6;

The first gate electrode of the fourteenth transistor T14 is electrically connected to the first output node N01, the first electrode of the fourteenth transistor T14 is electrically connected to the high voltage line VGH, and the second electrode of the fourteenth transistor T14 is electrically connected to the first electrode of the fifteenth transistor T15;

The first gate electrode of the fifteenth transistor T15 is electrically connected to the second clock signal line CB, and the second electrode of the fifteenth transistor T15 is electrically connected to the sixth node N6;

The second output node control circuit includes a sixteenth transistor T16;

The first gate electrode of the sixteenth transistor T16 is electrically connected to the low voltage line VGL, the first electrode of the sixteenth transistor T16 is electrically connected to the sixth node N6, and the second electrode of the sixteenth transistor T16 is electrically connected to the second output node N02;

The output circuit includes a seventh transistor T7 and an eighth transistor T8;

The first gate electrode of the seventh transistor T7 is electrically connected to the first output node N01, the first electrode of the seventh transistor T7 is electrically connected to the high voltage line VGH, and the second electrode of the seventh transistor T7 is electrically connected to the driving signal output terminal OT;

The first gate electrode of the eighth transistor T8 is electrically connected to the second output node N02, the first electrode of the eighth transistor T8 is electrically connected to the driving signal output terminal OT, and the second electrode of the eighth transistor T8 is electrically connected to the second clock signal line CB;

The driving circuit also includes a first capacitor C1 and a second capacitor C2;

The first electrode plate of the first capacitor C1 is electrically connected to the first output node N01, and the second electrode plate of the first capacitor C1 is electrically connected to the high voltage line VGH;

The first electrode plate of the second capacitor C2 is electrically connected to the second output node N02, and the second electrode plate of the second capacitor C2 is electrically connected to the driving signal output terminal OT.

In one embodiment of the driving circuit shown in FIG. 24, all transistors are p-type transistors, but the present invention is not limited thereto.

In at least one embodiment of the present disclosure, the orthographic projection of the bottom gate via hole of the eleventh transistor on the base substrate, the orthographic projection of the bottom gate via hole of the ninth transistor on the base substrate, and the orthographic projection of the bottom gate via hole of the sixteenth transistor on the base substrate are arranged along a first direction.

In a specific implementation, the orthographic projection of the bottom gate via hole of the eleventh transistor on the base substrate, the orthographic projection of the bottom gate via hole of the ninth transistor on the base substrate, and the orthographic projection of the bottom gate via hole of the sixteenth transistor on the base substrate can be arranged along a first direction to narrow the lateral space occupied by the driving circuit, for example, to achieve a narrow frame.

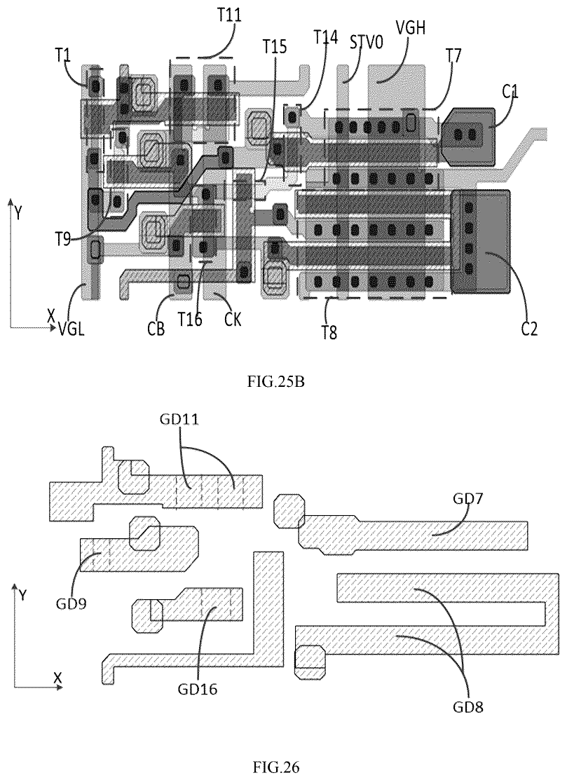

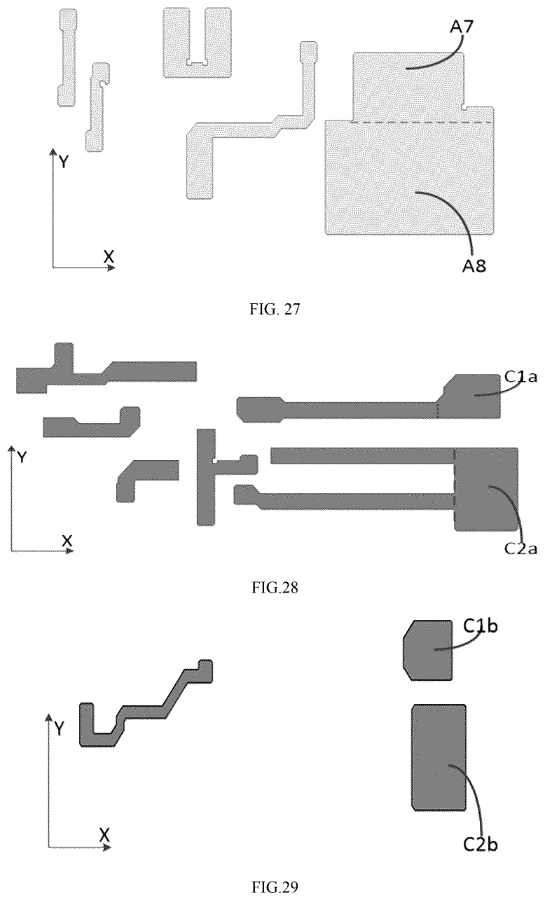

FIGS. 25A and 25B are layout diagrams of at least one embodiment of the driving circuit shown in FIG. 24, FIG. 26 is a layout diagram of the light shielding metal layer in FIG. 25A, FIG. 27 is a layout diagram of the semiconductor layer in FIG. 25A, FIG. 28 is a layout diagram of the first gate electrode metal layer in FIG. 25A, FIG. 29 is a layout diagram of the second gate electrode metal layer in FIG. 25A, FIG. 30 is a layout diagram of the first source-drain metal layer in FIG. 25A, and FIG. 31 is a layout diagram of the second source-drain metal layer in FIG. 25A.

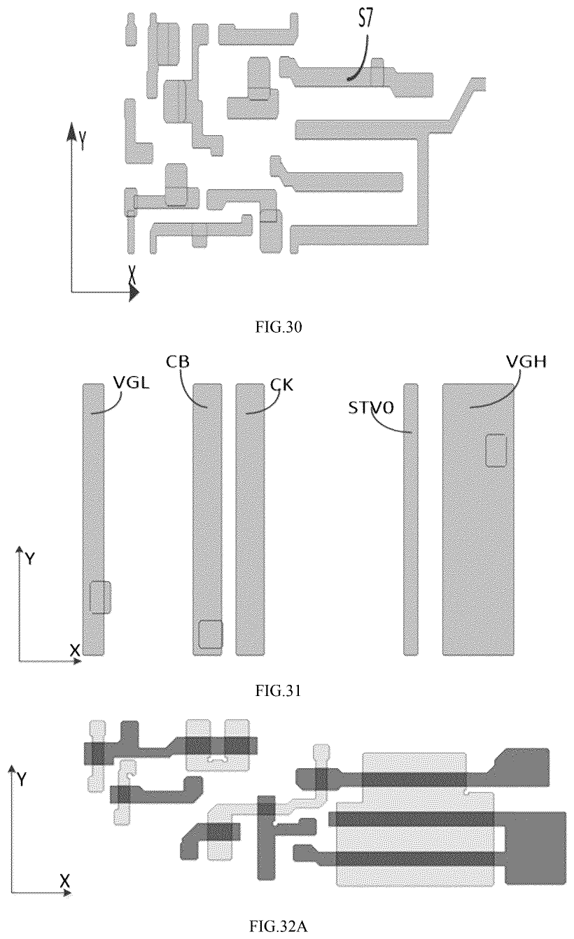

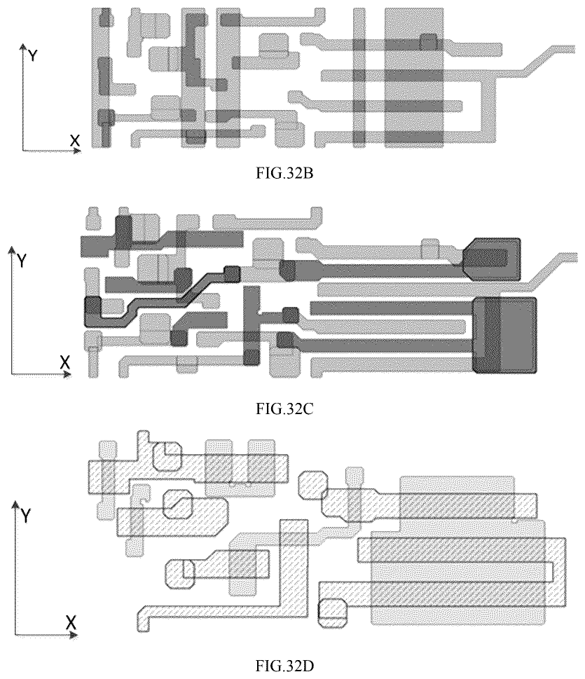

FIG. 32A is a schematic diagram of the superposition of the semiconductor layer and the first gate electrode metal layer in FIG. 25A, FIG. 32B is a schematic diagram of the superposition of the first source-drain metal layer and the second source-drain metal layer in FIG. 25A, FIG. 32C is a schematic diagram of the superposition of the first gate electrode metal layer, the second gate electrode metal layer and the first source-drain metal layer in FIG. 25A; FIG. 32D is a schematic diagram of the superposition of the light shielding metal layer and the semiconductor layer in FIG. 25A.

In FIG. 25A, the one labeled HG11 is the bottom gate via hole of the eleventh transistor T11, the one labeled HG9 is the bottom gate via hole of the ninth transistor T9, and the one labeled HG16 is the bottom gate via hole of the sixteenth transistor T16;

HG11, HG9, and HG16 are arranged in a vertical direction to narrow the lateral space occupied by the driving circuit, for example, to achieve a narrow frame.

In at least one embodiment of the present disclosure, an orthographic projection of the bottom gate via hole of the seventh transistor on the base substrate and an orthographic projection of the bottom gate via hole of the eighth transistor on the base substrate are arranged along a first direction.

In a specific implementation, the orthographic projection of the bottom gate via hole of the seventh transistor on the base substrate and the orthographic projection of the bottom gate via hole of the eighth transistor on the base substrate are arranged along the first direction to narrow the lateral space occupied by the driving circuit, for example, to achieve a narrow frame.

In FIG. 25A, the one labeled HG7 is the bottom gate via hole of the seventh transistor T7, and the one labeled HG8 is the bottom gate via hole of the eighth transistor T8, and HG7 and HG8 are arranged in the vertical direction.

In at least one embodiment of the present disclosure, the eleventh transistor in the current stage of driving circuit, the first transistor in the current stage of driving circuit and the fifteenth transistor in the adjacent previous stage of driving circuit share a bottom gate via hole of the transistor.

In a specific implementation, two transistors in a current stage of driving circuit and one transistor in an adjacent previous stage of driving circuit share a bottom gate via hole, so as to reduce the number of bottom gate via holes, thereby achieving the goal of reducing space.

In FIG. 25B, VGL is a low voltage line, CB is a second clock signal line, CK is a first clock signal line, STV is a start voltage line, and VGH is a high voltage line.

In FIG. 26, GD7 is the second gate electrode of T7, GD8 is the second gate electrode of T8, GD9 is the second gate electrode of T9, GD11 is the second gate electrode of T11, and GD16 is the second gate electrode of T16.

In FIG. 27, A7 is an active pattern of T7, and A8 is an active pattern of T8.

In FIG. 28, C1a is the first electrode plate of C1, C2a is the first electrode plate of C2, in FIG. 29, C1b is the second electrode plate of C1, C2b is the second electrode plate of C2. In FIG. 30, S7 is the first electrode of T7.

In FIG. 31, VGL is a low voltage line, CB is a second clock signal line, CK is a first clock signal line, STV is a start voltage line, and VGH is a high voltage line.

The display device described in the embodiment of the present disclosure includes the above-mentioned display substrate.

The above descriptions are implementations of the present disclosure. It should be pointed out that those skilled in the art can make some improvements and modifications without departing from the principle of the present disclosure. These improvements and modifications shall also fall within the scope of the present disclosure.

1. A display substrate, comprising a base substrate, a scan line and a driving module arranged on the base substrate, wherein the driving module includes a plurality of stages of driving circuits, and the driving circuit is configured to provide a driving signal for the scan line;
at least two transistors in the driving circuit have a first gate electrode and a second gate electrode; at least a portion of the second gate electrode is located between the first gate electrode and the base substrate;
bottom gate via holes of at least two transistors of the driving circuit are arranged along a first direction;
the second gate electrode is electrically connected to a connection portion through the bottom gate via hole, and the connection portion is electrically connected to the first gate electrode; or, the second gate electrode is electrically connected to the first gate electrode through the bottom gate via hole;
the first direction intersects with a second direction, and the scan line includes at least a portion extending along the second direction.

2. The display substrate according to claim 1, wherein an orthographic projection of a bottom gate via hole of at least one transistor included in the driving circuit on the base substrate and an orthographic projection of an electrode of another transistor electrically connected to the at least one transistor on the base substrate are arranged along the first direction.

3. The display substrate according to claim 1, wherein a minimum distance between an orthographic projection of a bottom gate via hole of at least one transistor included in the driving circuit and an orthographic projection of an electrode of another transistor electrically connected to the at least one transistor on the base substrate is smaller than a distance threshold.

4. The display substrate according to claim 1, wherein the driving circuit comprises an output circuit, the output circuit is electrically connected to a first output node, a second output node and a driving signal output terminal respectively, and is configured to generate a driving signal under the control of a potential of the first output node and a potential of the second output node, and provide the driving signal through the driving signal output terminal;
a length of an active pattern of at least one transistor included in the output circuit along the second direction is smaller than a first length threshold.

5. The display substrate according to claim 4, wherein the active pattern includes N mutually independent active pattern portions, the active pattern portions extend along the second direction, and N is an integer greater than 1.

6. The display substrate according to claim 1, wherein the driving circuit includes at least one energy storage circuit, and the energy storage circuit includes a capacitor;
a length of an orthographic projection of at least one capacitor included in the driving circuit on the base substrate along the second direction is smaller than a second length threshold.

7. The display substrate according to claim 1, wherein the driving circuit includes a first node control circuit, a second node control circuit, a first output node setting circuit, a third node control circuit, a first output node control circuit, a control node control circuit, a second output node control circuit, a first energy storage circuit, and an output circuit;
the first node control circuit is electrically connected to the first node and is configured to control a potential of the first node;
the second node control circuit is electrically connected to the second node and is configured to control a potential of the second node;
the first output node setting circuit is electrically connected to a control node, a first output node and a first voltage line respectively, and is configured to control the connection between the first output node and the first voltage line under the control of a potential of the control node;
the third node control circuit is electrically connected to a first node and a third node respectively, and is configured to control a potential of the third node under the control of a potential of the first node;
the first output node control circuit is electrically connected to the third node, a second clock signal line and the first output node respectively, and is configured to control the connection or disconnection between the third node and the first output node under the control of a second clock signal provided by the second clock signal line;
the control node control circuit is electrically connected to an initial control line, the first voltage line and the control node respectively, and is configured to control the connection or disconnection between the control node and the first voltage line under the control of an initial control signal provided by the initial control line;
the second output node control circuit is electrically connected to a second output node and a fourth node respectively, and is configured to control a potential of the second output node according to a potential of the fourth node;
the first energy storage circuit is electrically connected to the second node and the fourth node respectively, and is configured to store electrical energy;
the output circuit is electrically connected to the first output node, the second output node and the driving signal output terminal respectively, and is configured to control to output the driving signal under the control of a potential of the first output node and a potential of the second output node, and provide the driving signal through the driving signal output terminal.

8. The display substrate according to claim 7, wherein the first node control circuit includes a first transistor, and the second node control circuit includes a second transistor; the first output node setting circuit includes a third transistor, and the first output node control circuit includes a fourth transistor; the first energy storage circuit includes a first capacitor;
the control node control circuit includes a fifth transistor, the second output node control circuit includes a sixth transistor; the output circuit includes a seventh transistor and an eighth transistor;
a first gate electrode of the first transistor is electrically connected to a first clock signal line, a first electrode of the first transistor is electrically connected to a second voltage line, and a second electrode of the first transistor is electrically connected to the first node;
a first gate electrode of the second transistor is electrically connected to the first node, a first electrode of the second transistor is electrically connected to the first voltage line, and a second electrode of the second transistor is electrically connected to the second node;
a first gate electrode of the third transistor is electrically connected to the control node, a first electrode of the third transistor is electrically connected to the first voltage line, and a second electrode of the third transistor is electrically connected to the first output node;
a first gate electrode of the fourth transistor is electrically connected to the second clock signal line, a first electrode of the fourth transistor is electrically connected to the third node, and a second electrode of the fourth transistor is electrically connected to the first output node;
a first gate electrode of the fifth transistor is electrically connected to the initial control line, a first electrode of the fifth transistor is electrically connected to the first voltage line, and a second electrode of the fifth transistor is electrically connected to the control node;
a first gate electrode of the sixth transistor and a first electrode of the sixth transistor are electrically connected to the third node, and a second electrode of the sixth transistor is electrically connected to the second output node;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second voltage line;
a first electrode plate of the first capacitor is electrically connected to the second node, and a second electrode plate of the first capacitor is electrically connected to the fourth node.

9. The display substrate according to claim 7, wherein an orthographic projection of a bottom gate via hole of the fourth transistor on the base substrate, an orthographic projection of a bottom gate via hole of the seventh transistor on the base substrate, an orthographic projection of a bottom gate via hole of the third transistor on the base substrate, an orthographic projection of a bottom gate via hole of the fifth transistor on the base substrate and an orthographic projection of a bottom gate via hole of the eighth transistor on the base substrate are arranged along the first direction; or
wherein an orthographic projection of a bottom gate via hole of the second transistor on the base substrate and an orthographic projection of the second electrode of the first transistor on the base substrate are arranged along the first direction.

10. (canceled)

11. The display substrate according to claim 7, wherein the control node is directly connected to the second output node; or,
the driving circuit also includes a first on-off control circuit;
the first on-off control circuit is electrically connected to the second voltage line, the control node and the second output node respectively, and is configured to control the connection or disconnection between the control node and the second output node under the control of a second voltage signal provided by the second voltage line,
wherein the driving circuit further includes a first on-off control circuit; the first on-off control circuit includes a ninth transistor;
a first gate electrode of the ninth transistor is electrically connected to the second voltage line, a first electrode of the ninth transistor is electrically connected to the control node, and a second electrode of the ninth transistor is electrically connected to the second output node;
an orthographic projection of a bottom gate via hole of the ninth transistor on the base substrate and an orthographic projection of a bottom gate via hole of the sixth transistor on the base substrate are arranged along the first direction.

12. (canceled)

13. The display substrate according to claim 8, wherein a length of an orthographic projection of the first capacitor on the base substrate along the second direction is smaller than a second length threshold; or
wherein a length of the active pattern of the eighth transistor along the second direction is smaller than a first length threshold.

14. (canceled)

15. The display substrate according to claim 1, wherein the driving circuit includes a first node control circuit, a second node control circuit, a third node control circuit, a first output node control circuit, a first output node setting circuit, a control node control circuit, an output circuit, a first energy storage circuit, a second energy storage circuit, and a third energy storage circuit;
the first node control circuit is electrically connected to the first node and is configured to control the potential of the first node;
the second node control circuit is electrically connected to the second node and is configured to control the potential of the second node;
the first output node setting circuit is electrically connected to the control node, the first output node and the first voltage line respectively, and is configured to control the connection between the first output node and the first voltage line under the control of the potential of the control node;
the third node control circuit is electrically connected to the fifth node and the third node respectively, and is configured to control the potential of the third node under the control of the potential of the fifth node;
the first output node control circuit is electrically connected to the third node, the second clock signal line and the first output node respectively, and is configured to control the connection or disconnection between the third node and the first output node under the control of the second clock signal provided by the second clock signal line;
the control node control circuit is electrically connected to the input terminal, the first clock signal line, the initial control line, the first voltage line and the control node respectively, and is configured to control the connection or disconnection between the control node and the first voltage line under the control of the initial control signal provided by the initial control line, and control the connection or disconnection between the control node and the input terminal under the control of the first clock signal provided by the first clock signal line;
the first energy storage circuit is electrically connected to the second node and the second output node respectively, and is configured to store electrical energy;
a first terminal of the second energy storage circuit is electrically connected to the first node, a second terminal of the second energy storage circuit is electrically connected to the third node, and the second energy storage circuit is configured to store electrical energy;
the third energy storage circuit is electrically connected to the first output node and is configured to maintain the potential of the first output node;
the output circuit is electrically connected to the first output node, the second output node and the driving signal output terminal respectively, and is configured to control to output the driving signal under the control of the potential of the first output node and the potential of the second output node, and provide the driving signal through the driving signal output terminal.

16. The display substrate according to claim 15, wherein the first node control circuit includes a first transistor and a thirteenth transistor, and the second node control circuit includes a second transistor and a tenth transistor; the first output node setting circuit includes a third transistor, and the first output node control circuit includes a fourth transistor; the first energy storage circuit includes a first capacitor; the second energy storage circuit includes a second capacitor, and the third energy storage circuit includes a third capacitor; the control node control circuit includes a fifth transistor and an eleventh transistor, and the output circuit includes a seventh transistor and an eighth transistor; the third node control circuit includes a twelfth transistor;
a first gate electrode of the first transistor is electrically connected to a first clock signal line, a first electrode of the first transistor is electrically connected to a second voltage line, and a second electrode of the first transistor is electrically connected to the first node;
a first gate electrode of the thirteenth transistor is electrically connected to the control node, a first electrode of the thirteenth transistor is electrically connected to the first clock signal line, and a second electrode of the thirteenth transistor is electrically connected to the first node;
a first gate electrode of the second transistor is electrically connected to the first node, a first electrode of the second transistor is electrically connected to a first voltage line, and a second electrode of the second transistor is electrically connected to the second node;
a first gate electrode of the tenth transistor is electrically connected to the second output node, a first electrode of the tenth transistor is electrically connected to the second clock signal line, and a second electrode of the tenth transistor is electrically connected to the second node;
a first gate electrode of the third transistor is electrically connected to the control node, a first electrode of the third transistor is electrically connected to a first voltage line, and a second electrode of the third transistor is electrically connected to the first output node;
a first gate electrode of the fourth transistor is electrically connected to the second clock signal line, a first electrode of the fourth transistor is electrically connected to the third node, and a second electrode of the fourth transistor is electrically connected to the first output node;
a first gate electrode of the fifth transistor is electrically connected to the initial control line, a first electrode of the fifth transistor is electrically connected to the first voltage line, and a second electrode of the fifth transistor is electrically connected to the control node;
a first gate electrode of the eleventh transistor is electrically connected to the first clock signal line, a first electrode of the eleventh transistor is electrically connected to the input terminal, and a second electrode of the eleventh transistor is electrically connected to the control node;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second voltage line;
a first gate electrode of the twelfth transistor is electrically connected to the first node, a first electrode of the twelfth transistor is electrically connected to the second clock signal line, and a second electrode of the twelfth transistor is electrically connected to the third node;
a first electrode plate of the first capacitor is electrically connected to the second node, and a second electrode plate of the first capacitor is electrically connected to the second output node;
a first electrode plate of the second capacitor is electrically connected to the first node, and a second electrode plate of the second capacitor is electrically connected to the third node;
a first electrode plate of the third capacitor is electrically connected to the first output node, and a second electrode plate of the third capacitor is electrically connected to the first voltage line.

17. The display substrate according to claim 16, wherein an orthographic projection of an electrode plate of the second capacitor on the base substrate is at least partially arranged around an orthographic projection of a bottom gate via hole of the eleventh transistor on the base substrate.

18. The display substrate according to claim 16, wherein an orthographic projection of the second electrode of the eleventh transistor on the base substrate and an orthographic projection of a bottom gate via hole of the thirteenth transistor on the base substrate are arranged along the first direction,
wherein an orthographic projection of a bottom gate via hole of the thirteenth transistor on the base substrate and an orthographic projection of the first electrode of the first transistor on the base substrate are arranged along the first direction.

19. (canceled)

20. The display substrate according to claim 16, wherein an orthographic projection of a bottom gate via hole of the twelfth transistor on the base substrate, an orthographic projection of a bottom gate via hole of the seventh transistor on the base substrate and an orthographic projection of a bottom gate via hole of the fifth transistor on the base substrate are arranged along the first direction; or
wherein an orthographic projection of a bottom gate via hole of the fourth transistor on the base substrate and an orthographic projection of the second electrode of the third transistor on the base substrate are arranged along the second direction; or
wherein an orthographic projection of a bottom gate via hole of the tenth transistor on the base substrate and an orthographic projection of a electrode plate of the first capacitor on the base substrate are arranged along the second direction; or
wherein a length of an active pattern of the eighth transistor along the second direction is smaller than a first length threshold; or
wherein the control node is directly connected to the second output node; the first node is electrically connected to a fifth node; or
the driving circuit further includes a first on-off control circuit and a second on-off control circuit;
the first on-off control circuit is electrically connected to the second voltage line, the control node and the second output node respectively, and is configured to control the connection or disconnection between the control node and the second output node under the control of the second voltage signal provided by the second voltage line;
the second on-off control circuit is electrically connected to the second voltage line, the first node and the fifth node respectively, and is configured to control the connection or disconnection between the first node and the fifth node under the control of the second voltage signal provided by the second voltage line.

21.-24. (canceled)

25. The display substrate according to claim 1, wherein the driving circuit comprises a first output node control circuit, a sixth node control circuit, a second output node control circuit and an output circuit;
the first output node control circuit is configured to control a potential of the first output node;
the sixth node control circuit is configured to control a potential of the sixth node;
the second output node control circuit is configured to control a potential of the second output node according to the potential of the sixth node;
the output circuit is configured to control to provide the driving signal through the driving signal output terminal under the control of the potential of the first output node and the potential of the second output node.

26. The display substrate according to claim 25, wherein the first output node control circuit comprises a first transistor and a ninth transistor;
a first gate electrode of the first transistor is electrically connected to a first clock signal line, a first electrode of the first transistor is electrically connected to a second voltage line, and a second electrode of the first transistor is electrically connected to the first output node;
a first gate electrode of the ninth transistor is electrically connected to the sixth node, a first electrode of the ninth transistor is electrically connected to the first clock signal line, and a second electrode of the ninth transistor is electrically connected to the first output node;
the sixth node control circuit includes an eleventh transistor, a fourteenth transistor and a fifteenth transistor;
a first gate electrode of the eleventh transistor is electrically connected to the first clock signal line, a first electrode of the eleventh transistor is electrically connected to the input terminal, and a second electrode of the eleventh transistor is electrically connected to the sixth node;
a first gate electrode of the fourteenth transistor is electrically connected to the first output node, a first electrode of the fourteenth transistor is electrically connected to the first voltage line, and a second electrode of the fourteenth transistor is electrically connected to a first electrode of the fifteenth transistor;
a first gate electrode of the fifteenth transistor is electrically connected to the second clock signal line, and a second electrode of the fifteenth transistor is electrically connected to the sixth node;
the second output node control circuit includes a sixteenth transistor;
a first gate electrode of the sixteenth transistor is electrically connected to the second voltage line, a first electrode of the sixteenth transistor is electrically connected to the sixth node, and a second electrode of the sixteenth transistor is electrically connected to the second output node;
the output circuit includes a seventh transistor and an eighth transistor;
a first gate electrode of the seventh transistor is electrically connected to the first output node, a first electrode of the seventh transistor is electrically connected to the first voltage line, and a second electrode of the seventh transistor is electrically connected to the driving signal output terminal;
a first gate electrode of the eighth transistor is electrically connected to the second output node, a first electrode of the eighth transistor is electrically connected to the driving signal output terminal, and a second electrode of the eighth transistor is electrically connected to the second clock signal line.

27. The display substrate according to claim 26, wherein an orthographic projection of a bottom gate via hole of the eleventh transistor on the base substrate, an orthographic projection of a bottom gate via hole of the ninth transistor on the base substrate, and an orthographic projection of a bottom gate via hole of the sixteenth transistor on the base substrate are arranged along the first direction; or
wherein an orthographic projection of a bottom gate via hole of the seventh transistor on the base substrate and an orthographic projection of a bottom gate via hole of the eighth transistor on the base substrate are arranged along the first direction; or
wherein the eleventh transistor in a current stage of driving circuit, the first transistor in the current stage of driving circuit and the fifteenth transistor in an adjacent previous stage of driving circuit share a bottom gate via hole.

28. (canceled)

29. (canceled)

30. A display device comprising the display substrate according to claim 1.
